(19) United States
(12) Patent Application Publication
(10) Pub. No.: US 2026/0171104 A1
(43) Pub. Date: Jun. 18, 2026

(54) SPEECH SEPARATION METHOD

(71) Applicant: ALIBABA INNOVATION PRIVATE LIMITED, Singapore (SG)

(72) Inventor: Shengkui ZHAO, Singapore (SG)

(21) Appl. No.: 19/119,922

(22) PCT Filed: Dec. 14, 2023
(86) PCT No.: PCT/CN2023/138896

§ 371 Date: Apr. 10, 2025

(30) Foreign Application Priority Data
Dec. 28, 2022 (CN) 202211696827.1

(51) Int. Cl. G10L 21/0272; G10L 25/30

(52) U.S. Cl. CPC G10L 21/0272; G10L 25/30

(57) ABSTRACT

A speech separation method includes: acquiring (S402) a speech information sequence; extracting (S404) speech features of different pronunciation objects from the speech information sequence to obtain a speech feature sequence; performing (S406) a gated processing on the speech features in the speech feature sequence according to a local attention mechanism and a global attention mechanism to obtain a gated processing result; acquiring (S408) speech mask information of the different pronunciation objects based on the gated processing result; and separating (S410) speech information output by the different pronunciation objects from the speech information sequence based on the speech mask information of the different pronunciation objects and the speech feature sequence.

### CROSS-REFERENCE TO RELATED APPLICATIONS

The present application is a National Stage of International Application No. PCT/CN2023/138896, filed on Dec. 14, 2023, which claims priority to Chinese Patent Application No. 202211696827.1, filed with China National Intellectual Property Administration on Dec. 28, 2022 and entitled “SPEECH SEPARATION METHOD”. The two applications are hereby incorporated by reference in their entireties.

### TECHNICAL FIELD

One or more embodiments of the present application relate to the field of audio processing and, in particular, to a speech separation method.

### BACKGROUND

Currently, when multiple people communicate at the same time, if a speech separation is not performed, it will directly affect a speech recognition system or the auditory perception and the comprehension.

In related art, when processing a speech, only a single source speech is directly separated from a single overlapping mixed speech. Since the method is not used to perform a speech separation on the speech but is used to directly perform an extraction on the mixed speech, there is a technical problem that the effect of speech separation is poor.

No effective solution has been proposed to address the above problem.

### SUMMARY

An embodiment of the present application provides a speech separation method to at least solve a technical problem of being unable to perform a speech separation on the speech.

According to one aspect of an embodiment of the present application, a speech separation method is provided. The method may include: acquiring a speech information sequence, where the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; and separating speech information output by the different pronunciation objects from the speech information sequence based on the speech mask information of the different pronunciation objects and the speech feature sequence.

According to another aspect of an embodiment of the present application, a speech separation method is provided. The method may include: acquiring a speech information sequence, where the speech information sequence includes at least one piece of speech information to be speech separated, and different speech information originates from different pronunciation objects; calling a speech separation model, where the speech separation model is obtained by training based on a local attention mechanism and a global attention mechanism; extracting speech features of the different pronunciation objects from the speech information sequence to obtain a speech feature sequence by using the speech separation model, and performing a gated processing on the speech features in the speech feature sequence according to the local attention mechanism and the global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; and separating speech information output by the different pronunciation objects from the speech information sequence based on the speech mask information of the different pronunciation objects and the speech feature sequence.

According to another aspect of an embodiment of the present application, a speech separation method is provided. The method may include: extracting speech features of different pronunciation objects from an acquired speech information sequence to obtain a speech feature sequence, where the speech information sequence includes at least one piece of speech information to be speech separated, and different speech information originates from the different pronunciation objects; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and playing the speech information output by the different pronunciation objects respectively.

According to another aspect of an embodiment of the present application, a speech separation method is provided. The method may include: extracting speech features of different pronunciation objects from an acquired speech information sequence to obtain a speech feature sequence, where the speech information sequence includes at least one piece of speech information to be speech separated, and different speech information originates from the different pronunciation objects; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and inputting the speech information output by the different pronunciation objects into a speech recognition terminal, where the speech information is used to be recognized by the speech recognition terminal.

According to another aspect of an embodiment of the present application, a speech separation method is provided. The method may include: acquiring a speech information sequence by calling a first interface, where the first interface includes a first parameter, a parameter value of the first parameter is the voice information sequence, the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and outputting the speech information output by the different pronunciation objects by calling a second interface, where the second interface includes a second parameter, and a value of the second parameter is the speech information output by the different pronunciation objects.

According to another aspect of an embodiment of the present application, a speech separation apparatus is provided. The apparatus may include: a first acquiring unit, configured to acquire a speech information sequence, where the speech information sequence includes at least one piece of speech information to be speech separated, and different speech information originates from different pronunciation objects; a first extracting unit, configured to extract speech features of the different pronunciation objects from the speech information sequence to obtain a speech feature sequence; a first processing unit, configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; a second acquiring unit, configured to acquire speech mask information of the different pronunciation objects based on the gated processing result, where the speech mask information is used to represent a pronunciation attribute of the pronunciation object; and a first separating unit, configured to separate speech information output by the different pronunciation objects from the speech information sequence based on the speech mask information of the different pronunciation objects and the speech feature sequence.

According to another aspect of an embodiment of the present application, another speech separation apparatus is provided. The apparatus may include: a third acquiring unit, configured to acquire a speech information sequence, where the speech information sequence includes at least one piece of speech information to be speech separated, and different speech information originates from different pronunciation objects; a first calling unit, configured to call a speech separation model, where the speech separation model is obtained by training based on a local attention mechanism and a global attention mechanism; a second extracting unit, configured to extract speech features of the different pronunciation objects from the speech information sequence to obtain a speech feature sequence by using the speech separation model, and perform a gated processing on the speech features in the speech feature sequence according to the local attention mechanism and the global attention mechanism to obtain a gated processing result, where the gated processing result includes local speech information and global speech information of the different pronunciation objects, and an information granularity of the local speech information is smaller than an information granularity of the global speech information; a fourth acquiring unit, configured to acquire speech mask information of the different pronunciation objects based on the gated processing result, where the speech mask information is used to represent a pronunciation attribute of the pronunciation object; and a second separating unit, configured to separate speech information output by the different pronunciation objects from the speech information sequence based on the speech mask information of the different pronunciation objects and the speech feature sequence.

According to another aspect of an embodiment of the present application, another speech separation apparatus is provided. The apparatus may include: a third extracting unit, configured to extract speech features of different pronunciation objects from an acquired speech information sequence to obtain a speech feature sequence, where the speech information sequence includes at least one piece of speech information to be speech separated, and different speech information originates from the different pronunciation objects; a second processing unit, configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; a fifth acquiring unit, configured to acquire speech mask information of the different pronunciation objects based on the gated processing result, where the speech mask information is used to represent a pronunciation attribute of the pronunciation object; a third separating unit, configured to separate speech information output by the different pronunciation objects from the speech information sequence based on the speech mask information of the different pronunciation objects and the speech feature sequence; and a playing unit, configured to play the speech information output by the different pronunciation objects respectively.

According to another aspect of an embodiment of the present application, another speech separation apparatus is provided. The apparatus may include: a fourth extracting unit, configured to extract speech features of different pronunciation objects from an acquired speech information sequence to obtain a speech feature sequence, where the speech information sequence includes at least one piece of speech information to be speech separated, and different speech information originates from the different pronunciation objects; a third processing unit, configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; a sixth acquiring unit, configured to acquire speech mask information of the different pronunciation objects based on the gated processing result, where the speech mask information is used to represent a pronunciation attribute of the pronunciation object; a fourth separating unit, configured to separate speech information output by the different pronunciation objects from the speech information sequence based on the speech mask information of the different pronunciation objects and the speech feature sequence; and an inputting unit, configured to input the speech information output by the different pronunciation objects into a speech recognition terminal, where the speech information is used to be recognized by the speech recognition terminal.

According to another aspect of an embodiment of the present application, another speech separation apparatus is provided. The apparatus may include: a seventh acquiring unit, configured to acquire a speech information sequence by calling a first interface, where the first interface includes a first parameter, a parameter value of the first parameter is the voice information sequence, the speech information sequence includes at least one piece of speech information to be speech separated, and different speech information originates from different pronunciation objects; a fourth processing unit, configured to extract speech features of the different pronunciation objects from the speech information sequence to obtain a speech feature sequence; a fifth processing unit, configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; an eighth acquiring unit, configured to acquire speech mask information of the different pronunciation objects based on the gated processing result, where the speech mask information is used to represent a pronunciation attribute of the pronunciation object; a fifth separating unit, configured to separate speech information output by the different pronunciation objects from the speech information sequence based on the speech mask information of the different pronunciation objects and the speech feature sequence; and an outputting unit, configured to output the speech information output by the different pronunciation objects by calling a second interface, where the second interface includes a second parameter, and a value of the second parameter is the speech information output by the different pronunciation objects.

According to another aspect of an embodiment of the present application, a computer-readable storage medium is also provided, the computer-readable storage medium includes a stored program, the program, when run, controls a device on which the storage medium is located to execute the speech separation method according to any one of the above aspects.

According to another aspect of an embodiment of the present application, a processor is also provided, the processor is configured to run a program, the program, when run, executes the speech separation method according to any one of the above aspects.

In an embodiment of the present application, a speech information sequence is acquired, where the speech information sequence includes at least one piece of speech information to be speech separated, and different speech information originates from different pronunciation objects; speech features of the different pronunciation objects are extracted from the speech information sequence to obtain a speech feature sequence; a gated processing is performed on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; speech mask information of the different pronunciation objects is acquired based on the gated processing result, where the speech mask information is used to represent a pronunciation attribute of the pronunciation object; and speech information output by the different pronunciation objects is separated from the speech information sequence based on the speech mask information of the different pronunciation objects and the speech feature sequence. That is, the embodiment of the present application performs the gated processing on the acquired speech features in the speech feature sequence according to the local attention mechanism and the global attention mechanism, and can obtain the local speech information and the global speech information of the different pronunciation objects. Based on the gated processing, a requirement of the local attention mechanism and the global attention mechanism is substantially reduced, so that not only global information can be directly processed, but also smaller local features can be processed, thereby realizing the technical effect of being able to perform a speech separation on the speech, and thereby solving the technical problem of being unable to perform a speech separation on the speech.

### BRIEF DESCRIPTION OF DRAWINGS

The accompanying drawings illustrated herein are used to provide a further understanding of the present application and form a part of the present application. The schematic embodiments of the present application and the descriptions thereof are used to explain the present application and do not constitute an undue limitation of the present application. In the accompanying drawings:

FIG. 1 is a hardware structure block diagram of a computer terminal (or a mobile device) for implementing a speech separation method according to an embodiment of the present application.

FIG. 2 is a structure block diagram of a computing environment according to an embodiment of the present application.

FIG. 3 is a structure block diagram of a service grid according to an embodiment of the present application.

FIG. 4 is a flowchart of a speech separation method according to an embodiment of the present application.

FIG. 5 is a flowchart of another speech separation method according to an embodiment of the present application.

FIG. 6 is a flowchart of another speech separation method according to an embodiment of the present application.

FIG. 7 is a flowchart of another speech separation method according to an embodiment of the present application.

FIG. 8 is a flowchart of another speech separation method according to an embodiment of the present application.

FIG. 9 is a schematic diagram of an accessing to a private network by a computer device according to an embodiment of the present application.

FIG. 10 is a schematic diagram of a deep network model based on an attention mechanism according to an embodiment of the present application;

FIG. 11 is a schematic diagram of a local and global hybrid attention mechanism framework based on a gated mechanism according to an embodiment of the present application.

FIG. 12 is a schematic diagram of a convolution module according to an embodiment of the present application.

FIG. 13 is a schematic diagram of a speech separation apparatus according to an embodiment of the present application.

FIG. 14 is a schematic diagram of another speech separation apparatus according to an embodiment of the present application.

FIG. 15 is a schematic diagram of another speech separation apparatus according to an embodiment of the present application.

FIG. 16 is a schematic diagram of another speech separation apparatus according to an embodiment of the present application.

FIG. 17 is a schematic diagram of another speech separation apparatus according to an embodiment of the present application.

FIG. 18 is a structure block diagram of a computer terminal according to an embodiment of the present application.

### DESCRIPTION OF EMBODIMENTS

In order to enable a person skilled in the art to better understand the present application, the technical solutions in the embodiments of the present application will be clearly and completely described below in conjunction with the accompanying drawings in the embodiments of the present application. Obviously, the described embodiments are only a part of the embodiments of the present application, rather than all of the embodiments. Based on the embodiments in the present application, all other embodiments obtained by a person of ordinary skill in the art without making any creative work should fall within the scope of protection of the present application.

It should be noted that terms “first”, “second”, etc. in the specification, claims and the above accompanying drawings of the present application are used to distinguish similar objects, and are not necessarily used to describe a specific order or a sequence. It is to be understood that the term so used can be interchangeable where appropriate, so that the embodiments of the present application described herein can be implemented in an order other than those illustrated or described herein. In addition, terms “including” and “having” and any variations thereof, are intended to cover non-exclusive inclusions. For example, a process, a method, a system, a product, or a device that includes a series of steps or units is not necessarily limited to those steps or units explicitly listed, but may include other steps or units not explicitly listed or inherent to the process, the method, the product, or the device.

First, some nouns or terms appearing in the description of the embodiments of the present application are applicable to the following explanations.

Speech separation, which can separate a mixed speech of multiple speakers and obtain individual speeches of all speakers;

Self-attention mechanism (Self-attention), which can be a sequence processing module algorithm used in a deep learning model (for example, a Transformer model);

Deep learning algorithm (Deeplearning), which can be a model modeling method based on a multi-layer neural network;

Convolution, which can be a mathematical operator that generates a third function from two functions, and can represent an area of a curved trapezoid enclosed by a product function has been flipped and translated.

Cocktail problem, which refers to a problem that when multiple people communicate at the same time, if a speech separation is not performed after collecting by a microphone, it will directly affect a speech recognition system or the auditory perception and the comprehension.

### Embodiment 1

According to an embodiment of the present application, a speech separation method is provided. It should be noted that steps shown in a flowchart of an accompanying drawing can be executed in a computer system such as a set of computer executable instructions, and although a logical order is shown in the flowchart, in some cases, the steps shown or described can be executed in an order different from that shown here.

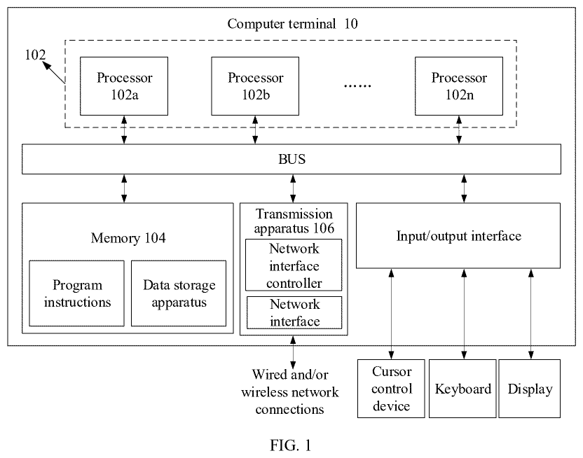

A method embodiment provided in Embodiment 1 of the present application can be executed in a mobile terminal, a computer terminal or a similar computing apparatus. FIG. 1 is a hardware structure block diagram of a computer terminal (or a mobile device) for implementing a speech separation method according to an embodiment of the present application. As shown in FIG. 1, a computer terminal 10 (or a mobile device) may include one or more processors 102 (shown as 102a, 102b, . . . , 102n in the figure) (the processor 102 may include but is not limited to a processing apparatus such as a microprocessor unit (MPU) or a field-programmable gate array FPGA), a memory 104 configured to store data, and a transmission apparatus 106 configured to communicate. In addition, it may also include: a display, an input/output interface (I/O interface), a universal serial bus (USB) port (which may be included as one of ports of the BUS), a network interface, a power supply and/or a camera. A person of ordinary skill in the art can understand that the structure shown in FIG. 1 is merely illustrative and does not limit a structure of the electronic apparatus described above. For example, the computer terminal 10 may also include more or fewer components than those shown in FIG. 1, or have a configuration different from that shown in FIG. 1.

It should be noted that the one or more processors 102 described above and/or other speech separation circuits can generally be referred to herein as “speech separation circuit”. The speech separation circuit may be embodied in whole or in part as software, hardware, firmware or any other combinations. In addition, the speech separation circuit may be a single independent processing module, or may be fully or partially integrated into any one of other components in the computer terminal 10 (or mobile device). As involved in the embodiment of the present application, the speech separation circuit is controlled as a processor (e.g., a selection of a variable resistor terminal path connected to an interface).

The memory 104 can be configured to store a software program and a module of application software, such as a program instructions/data storage apparatus corresponding to the speech separation method in the embodiment of the present application. The processor 102 executes various functional applications and data processing by running software program and module stored in the memory 104, that is, the above speech separation method is realized. The memory 104 may include a high-speed random access memory, and may also include a non-volatile memory, such as one or more magnetic storage apparatuses, flash memories, or other non-volatile solid-state memories. In some examples, the memory 104 may further include memories remotely configured relative to the processor 102, and these remote memories may be connected to the computer terminal 10 via a network. Examples of the above network include but are not limited to an internet, an intranet, a local area network, a mobile communication network and a combination thereof.

The transmission apparatus 106 is configured to receive or send data through one network. A specific example of the above network may include a wireless network provided by a communication provider of the computer terminal 10. In an example, the transmission apparatus 106 includes a network interface controller (NIC), which can be connected to other network devices through a base station so as to communicate with an internet. In an example, the transmission apparatus 106 may be a radio frequency (RF) module, which is configured to wirelessly communicate with an internet.

The display may be, for example, a touch screen liquid crystal display (LCD), which may enable a user to interact with a user interface of the computer terminal 10 (or mobile device).

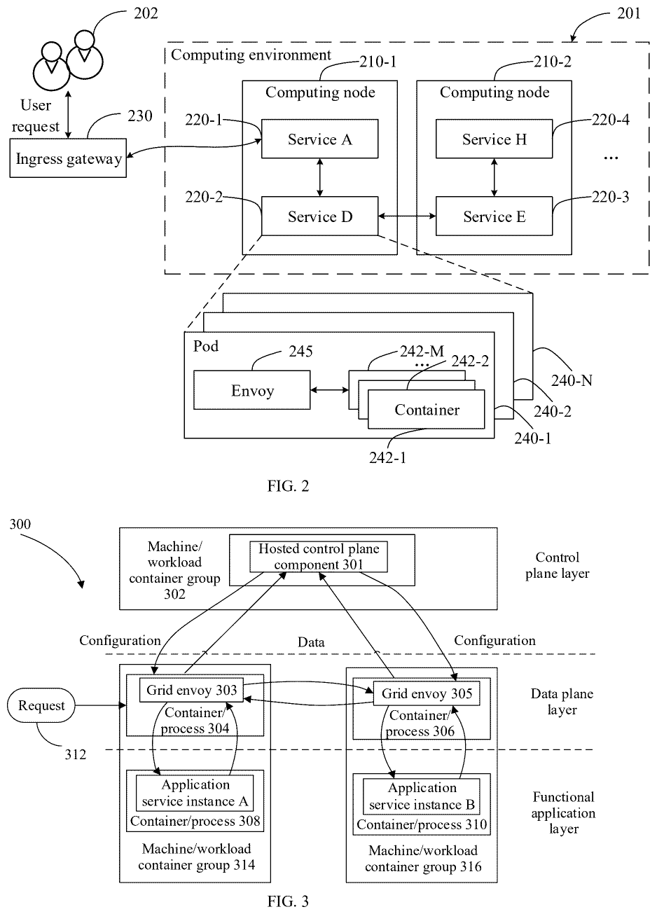

The hardware structure block diagram shown in FIG. 1 can not only serve as an exemplary block diagram of the above computer terminal 10 (or mobile device), but also as an exemplary block diagram of a server. In an embodiment, FIG. 2 shows in a block diagram an embodiment of using the computer terminal 10 (or mobile device) shown in FIG. 1 as a computing node in a computing environment 201. FIG. 2 is a structure block diagram of a computing environment according to an embodiment of the present application. As shown in FIG. 2, a computing environment 201 includes multiple computing nodes (shown as 210-1, 210-2, . . . , in the figure) (such as servers) running on a distributed network. Each computing node includes a local processing and a memory resource, and a terminal user 202 can remotely run an application or store data in the computing environment 201. The application may be provided as multiple services 220-1, 220-2, 220-3, and 220-4 in the computing environment 201, representing services “A”, “D”, “E”, and “H” respectively.

The terminal user 202 may provide an access service through a web browser or other software applications on client, and in some embodiments, provisions and/or requests of the terminal user 202 may be provided to an ingress gateway 230. The ingress gateway 230 may include a corresponding envoy to handle the provisions and/or the requests for services (one or more services provided in the computing environment 201).

Services are provided or deployed based on various virtualization technologies supported by the computing environment 201. In some embodiments, services may be provided according to the virtualization based on a virtual machine (VM), the virtualization based on a container, and/or other similar manners. The virtualization based on a virtual machine can be achieved by initializing a virtual machine to simulate a real computer and execute programs and applications without directly contacting any actual hardware resources. While a virtual machine virtualizing a machine, according to the virtualization based on a container, a container can be launched to virtualize an entire operating system (OS), so that multiple workloads can run on a single operating system instance.

In an embodiment of the virtualization based on a container, several containers of a service can be assembled into a Pod (e.g., a Kubernetes Pod). For example, as shown in FIG. 2, a service 220-2 may be configured with one or more Pods 240-1, 240-2, . . . , 240-N (collectively referred to as Pod). Each Pod may include an envoy 245 and one or more containers 242-1, 242-2, . . . , 242-M (collectively referred to as container). One or more containers in a Pod handle requests related to one or more corresponding functions of a service, and the envoy 245 typically controls a network function related to the service, such as a routing, a load balancing, etc. Other services can also be configured with one or more similar Pods.

During an operation, an execution of a user request from the terminal user 202 may require calling one or more services in the computing environment 201, and an execution of one or more functions of one service may require calling one or more functions of another service. As shown in FIG. 2, a service “A” 220-1 receives a user request of the terminal user 202 from the ingress gateway 230, the service “A” 220-1 may call a service “D” 220-2, and the service “D” 220-2 may request a service “E” 220-3 to execute one or more functions.

The above computing environment may be a cloud computing environment, where a resource allocation is managed by a cloud service, allowing for a development of functionality without having to consider implementation, adjustment or expansion of a server. In a case where without building or maintaining a complex infrastructure, the computing environment allows a developer to execute codes in response to an event. Rather than extending a single hardware device to handle potential load, a service can be segmented to a set of functions which can scale independently and automatically.

In another embodiment, FIG. 3 shows in a block diagram an embodiment of using the computer terminal 10 (or mobile device) shown in FIG. 1 as a service grid. FIG. 3 is a structure block diagram of a service grid according to an embodiment of the present application. As shown in FIG. 3, a service grid 300 is mainly configured to facilitate a secure and reliable communication between multiple microservices. Microservices refer to decomposing an application into multiple smaller services or instances, which are distributed on different clusters/machines to run.

As shown in FIG. 3, the microservices may include an application service instance A and an application service instance B, and the application service instance A and the application service instance B form a functional application layer of the service grid 300. In an implementation, the application service instance A runs in a form of container/process 308 on a machine/workload container group 314 (Pod), and the application service instance B runs in a form of container/process 310 on a machine/workload container group 316 (Pod).

In an implementation, the application service instance A may be a commodity query service, and the application service instance B may be a commodity ordering service.

As shown in FIG. 3, the application service instance A and a grid envoy (sidecar) 303 coexist in a machine/workload container group 314, and the application service instance B and a grid envoy 305 coexist in a machine/workload container 316. The grid envoy 303 and the grid envoy 305 form a data plane layer (dataplane) of the service grid 300, in which, the grid envoy 303 and the grid envoy 305 run in forms of container/process 304 and container/process 306 respectively, and can receive a request 312 for a commodity query service, and the grid envoy 303 and application service instance A can bidirectional communicate, and the grid envoy 305 and application service instance B can bidirectional communicate. In addition, the grid envoy 303 and the grid envoy 305 can bidirectional communicate with each other.

In an implementation, all traffic of the application service instance A is routed to suitable destinations through the grid envoy 303, and all network traffic of the application service instance B is routed to suitable destinations through the grid envoy 305. It should be noted that the network traffic mentioned here includes but is not limited to a form such as a hyper text transfer protocol (HTTP), a representational state transfer (REST), a high-performance, general open source framework (G Remote Procedure Call, GRPC), an open source in-memory data structure storage system (Redis), etc.

In an implementation, the functionality of the data plane layer can be extended by writing a custom filter for an envoy in the service grid 300. A service grid envoy configuration can be designed to enable a service grid to correctly envoy service traffic and achieve the service interoperability and the service governance. The grid envoy 303 and the grid envoy 305 can be configured to perform at least one of the following functions: service discovery, health checking, routing, load balancing, authentication and authorization, and observability.

As shown in FIG. 3, the service grid 300 also includes a control plane layer. The control plane layer may be a group of services running in a dedicated namespace, and these services are hosted by a hosted control plane component 301 in a machine/workload container group (machine/Pod) 302. As shown in FIG. 3, the hosted control plane component 301 is in bidirectional communication with the grid envoy 303 and the grid envoy 305. The hosted control plane component 301 is configured to perform some control management functions. For example, the hosted control plane component 301 receives telemetry data transmitted by the grid envoy 303 and the grid envoy 305 and may further aggregate the telemetry data. The hosted control plane component 301 may also provide an application programming interface (API) for users to manipulate a network behavior more easily, and provide configuration data to the grid envoy 303 and the grid envoy 305, etc.

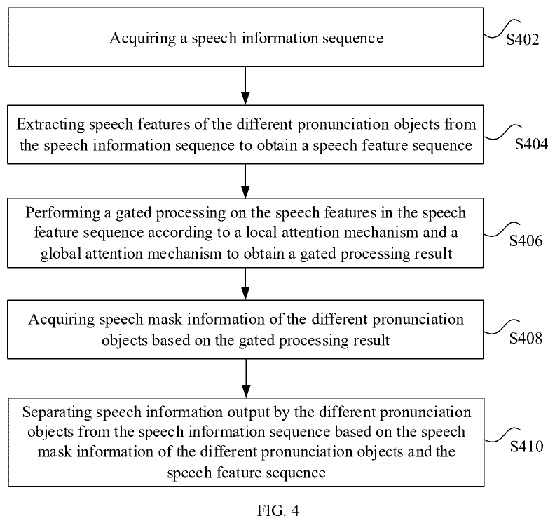

In the above operating environment, the present application provides a speech separation method as shown in FIG. 4. FIG. 4 is a flowchart of a speech separation method according to an embodiment of the present application. As shown in FIG. 4, the method may include the following steps.

Step S402, acquiring a speech information sequence, where the speech information sequence includes at least one piece of speech information to be speech separated, and different speech information originates from different pronunciation objects.

In the technical solution provided in the above step S402 of the present application, the speech information sequence can be obtained, where the speech information sequence (sequence X) can be mixed sound wave information including at least one piece of speech information to be separated, and the different speech information can originate from the different pronunciation objects. The pronunciation object may be a speaking object (speaker).

In an implementation, the speech information emitted by the different pronunciation objects can be acquired to obtain the speech information sequence.

Step S404, extracting speech features of the different pronunciation objects from the speech information sequence to obtain a speech feature sequence.

In the technical solution provided in the above step S404 of the present application, features can be extracted from the speech information sequence, the speech features of the different pronunciation objects can be extracted from the speech information sequence, and the speech feature sequence can be obtained based on the speech features of the different pronunciation objects in the speech information sequence. The speech feature may be a feature vector, which can be used to represent contents in the speech information sequence.

In an implementation, speech information of at least one pronunciation object is acquired to obtain the speech information sequence, which may be extracting features of the speech information in the speech information sequence by an encoder to obtain the speech features of the different pronunciation objects, thereby obtaining the speech feature sequence.

Step S406, performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

In the technical solution provided in the above step S406 of the present application, the gated processing can be performed on the speech features in the speech feature sequence respectively according to the local attention mechanism and the global attention mechanism to obtain the gated processing result, where the gated processing result includes the local speech information and the global speech information of the different pronunciation objects, and the information granularity of the local speech information is smaller than the information granularity of the global speech information. The gated processing may include adding processing, multiplying processing, and others on the speech features.

In an embodiment of the present application, a hybrid attention mechanism is proposed, which includes the local attention mechanism and the global attention mechanism. By utilizing the global attention mechanism and the local attention mechanism to learn a connection between local features and global features in the gated processing, the technical effect of being able to perform a speech separation on the speech is achieved, thereby solving the technical problem of being unable to perform a speech separation on the speech.

S408, acquiring speech mask information of the different pronunciation objects based on the gated processing result, where the speech mask information is used to represent a pronunciation attribute of the pronunciation object.

In the technical solution provided in the above step S408 of the present application, the speech mask information of the different pronunciation objects can be acquired based on the gated processing result, where the speech mask information (individual speaker's mask) can be used to represent the pronunciation attribute of the pronunciation object, which can be a mask matrix, for example, it can be a time-frequency point mask matrix. It should be noted that this is only an example and no specific limitation is imposed on the mask.

S410, separating speech information output by the different pronunciation objects from the speech information sequence based on the speech mask information of the different pronunciation objects and the speech feature sequence.

In the technical solution provided in the above step S410 of the present application, the speech information output by the different pronunciation objects can be separated from the speech information sequence based on the speech mask information of the different pronunciation objects and the speech feature sequence. For example, the speech information output by the different pronunciation objects can be separated from the speech information sequence by multiplying the speech mask information and the speech feature sequence.

By means of the above steps S402 to S410 of the present application, a speech information sequence is acquired, where the speech information sequence includes at least one piece of speech information to be speech separated, and different speech information originates from different pronunciation objects; speech features of the different pronunciation objects are extracted from the speech information sequence to obtain a speech feature sequence; a gated processing is performed on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; speech mask information of the different pronunciation objects is acquired based on the gated processing result, where the speech mask information is used to represent a pronunciation attribute of the pronunciation object; and speech information output by the different pronunciation objects is separated from the speech information sequence based on the speech mask information of the different pronunciation objects and the speech feature sequence. That is, the embodiment of the present application performs the gated processing on the acquired speech features in the speech feature sequence according to the local attention mechanism and the global attention mechanism, and can obtain the local speech information and the global speech information of the different pronunciation objects. Based on the gated processing, a requirement of the local attention mechanism and the global attention mechanism is substantially reduced, so that not only global information can be directly processed, but also smaller local features can be processed, thereby realizing the technical effect of being able to perform a speech separation on the speech, and thereby solving the technical problem of being unable to perform a speech separation on the speech.

The above method of the embodiment is further introduced below.

As an implementation, the local attention mechanism includes a single-head attention mechanism, and the global attention mechanism includes a linear attention mechanism, the performing the gated processing on the speech features in the speech feature sequence according to the local attention mechanism and the global attention mechanism to obtain the gated processing result includes: converting the speech features in the speech feature sequence according to the single-head attention mechanism to obtain the local speech information; converting the speech features in the speech feature sequence according to the linear attention mechanism to obtain the global speech information; and performing the gated processing on the local speech information and the global speech information to obtain the gated processing result.

In this embodiment, the local attention mechanism may include the single-head attention mechanism, and the global attention mechanism may include the linear attention mechanism, where the single-head attention mechanism can be a self-attention mechanism (Self Attention), and the linear attention mechanism can be a simplified linear attention mechanism. The speech features in the speech feature sequence can be converted according to the single-head attention mechanism to obtain the local speech information, and the speech features in the speech feature sequence can be converted according to the linear attention mechanism to obtain the global speech information. The gated processing can be performed on the local speech information and the global speech information to obtain the gated processing result.

In an embodiment of the present application, a multi-head attention mechanism in related art is simplified to the single-head attention mechanism by utilizing a gated. The speech features in the speech feature sequence can be converted according to the single-head attention mechanism, which only obtains the local speech information, thereby achieving a purpose of reducing the amount of calculation. At the same time, the speech features in the speech feature sequence can be converted according to the linear attention mechanism to obtain global information, thereby greatly simplifying the complexity of the algorithm.

As an implementation, a convolution processing is performed on the speech features in the speech feature sequence to obtain a speech feature matrix of a target dimension; and the converting the speech features in the speech feature sequence according to the linear attention mechanism to obtain the global speech information includes: converting the speech feature matrix according to the linear attention mechanism to obtain the global speech information.

In this embodiment, the convolution processing can be performed on the speech features in the speech feature sequence, and the speech feature matrix of the target dimension can be obtained, and the speech features in the speech feature sequence can be converted according to the linear attention mechanism to obtain the global speech information.

In an implementation, a parallel convolution (Convolution Module) processing can be performed on the speech features in the speech feature sequence, and the speech feature matrix of the target dimension can be obtained, for example, the speech feature matrix of the target dimension may be speech feature matrixes (U and V) of S*A dimension, and the speech feature matrix of the target dimension can be determined by the following formulas:

$$U = Conv M ( {X}^{″} )$$

$$V = Conv M ( {X}^{″} )$$

where ConvM can be used to represent a convolution module. Through a convolution, the speech features can be converted into the speech feature matrix of the target dimension, the speech features in the speech feature sequence can be converted according to the linear attention mechanism to obtain the global speech information. The global speech information (V_{global′} and U_{global′}) of the speech feature matrix V and the speech feature matrix U can be determined by the following linearized forms:

$${V}_{{global}^{′}} = {Q}^{′} ( β {K}^{′ T} V ) , {U}_{{global}^{′}} = {Q}^{′} ( β {K}^{′ T} U )$$

where β can be a time scaling coefficient; Q′ can be a corresponding feature sequence; and K′^{T} can be a key corresponding to the feature sequence.

As an implementation, the converting the speech features in the speech feature sequence according to the single-head attention mechanism to obtain the local speech information includes: converting a blocked speech feature matrix of the speech feature matrix according to the single-head attention mechanism to obtain the local speech information.

In this embodiment, the speech feature matrix can be divided into blocks, and a blocked speech feature matrix obtained after the block division is converted according to the single-head attention mechanism to obtain the local speech information. The blocked speech feature matrix may be a speech feature matrix of non-overlapping blocks.

In an implementation, the speech feature matrix can be divided into non-overlapping blocks of the same size by using zero padding, and the divided non-overlapping blocks can be converted according to the single-head attention mechanism to obtain the local speech information (V_{local,h′} and U_{local,h′}), which can be determined by the following formula:

$${V}_{local , h}^{′} = {RELU}^{2} ( γ {Q}_{h} {K}_{h}^{T} ) {V}_{h} , {U}_{local , h}^{′} = {RELU}^{2} ( γ {Q}_{h} {K}_{h}^{T} ) {U}_{h}$$

where γ can be a scaling coefficient; RELU² can be square of a rectified linear coefficient;

$${Q}_{h} {K}_{h}^{T}$$

can be calculated only one time, and Vₕ and Uₕ can be a blocked speech feature matrix obtained after performing a block division on the speech feature matrix.

In this embodiment, a squared rectified linear coefficient (RELU²) is used to replace a normalized exponential function (Softmax) in the multi-head attention mechanism, thereby achieving a purpose of further optimizing the model performance.

As an implementation, the performing the gated processing on the local speech information and the global speech information to obtain the gated processing result includes: acquiring combined speech information between the global speech information and the local speech information; and performing the gated processing on the combined speech information, the speech feature matrix and the speech feature sequence to obtain the gated processing result.

In this embodiment, the combined speech information between the global speech information and the local speech information can be acquired, and the gated processing can be performed on the combined speech information, the speech feature matrix and the speech feature sequence to obtain the gated processing result.

In an implementation, the combined speech information (V′ and U′) between the global speech information and the local speech information can be determined by the following formula:

$${V}^{′} = {V}_{global}^{′} + {V}_{local}^{′} , {U}^{′} = {U}_{global}^{′} + {U}_{local}^{′}$$

In an implementation, the gated processing can be performed on the combined speech information, the speech feature matrix and the speech feature sequence to obtain the gated processing result, where the gated processing may include: a feature (element) activation processing (ø), a feature summation processing (⊕), and a feature multiplication processing (⊗). The gated processing result (O′, O″, O) can be determined by the following formulas:

$${O}^{′} = ∅ ( U ⊗ {V}^{′} ) , where {V}^{′} = V * A$$

$${O}^{″} = {V}^{′} ⊗ {U}^{′} , where {U}^{′} = A * U$$

$$O = {X}^{″} + ConvM ( {O}^{′} ⊗ {O}^{″} )$$

where V′ can be combined speech information; A can be a convolution coefficient; U′ can be combined speech information; Ø can be an element activation function.

In this embodiment, the requirement for the attention mechanism can be greatly reduced by performing the gated processing, thereby achieving a purpose of simplifying the multi-head attention mechanism into the single-head attention mechanism, thereby greatly reducing the requirement for the local attention mechanism and the global attention mechanism.

In an implementation, for a long sentence, a data processing process takes a long time. Therefore, in the embodiment of the present application, a local speech feature matrix (U) and a global speech feature matrix (V) are combined by the gated processing in an efficient and effective manner, thereby improving the efficiency of the model in processing data.

As an implementation, the performing the convolution processing on the speech features in the speech feature sequence to obtain the speech feature matrix of the target dimension includes: performing the convolution processing on the speech features in the speech feature sequence for multiple times to obtain speech feature matrices of different target dimensions.

In this embodiment, the convolution processing can be performed on the speech feature sequence for multiple times to obtain the speech feature matrices of the different target dimensions.

For example, a pointwise convolution can be performed on the speech feature sequence to obtain a speech feature matrix of a target dimension of N*S, and the speech feature matrix of the target dimension of N*S can be convolved through another pointwise convolution to obtain a speech feature matrix of a target dimension of C*N*S.

As an implementation, the method also includes: performing a normalization processing on the speech feature sequence to obtain a normalized speech result; encoding the normalized speech result to obtain a speech encoding result; performing a convolution processing on the speech encoding result, and converting an obtained convolution result to obtain a speech feature matrix of an original dimension; where the performing the convolution processing on the speech features in the speech feature sequence to obtain the speech feature matrix of the target dimension includes: performing a convolution processing on the speech feature matrix of the original dimension to obtain the speech feature matrix of the target dimension.

In this embodiment, the normalization processing can be performed on the speech feature sequence to obtain the normalized speech result, the normalized speech result can be encoded to obtain the speech coding result, the convolution processing can be performed on the speech encoding result, and the obtained convolution result can be converted to obtain the speech feature matrix of the original dimension, and the convolution processing can be performed on the speech feature matrix of the original dimension to obtain the speech feature matrix of the target dimension.

In an implementation, the speech information sequence output by the encoder may first pass through a linear layer and be normalized (LayerNorm) to obtain the normalized speech result, where the normalized speech result may be the speech feature matrix. Positional encodings may be added to the normalized speech result to obtain the speech encoding result, where the added positional encodings may be sinusoidal positional encodings. This is only an example and is not specifically limited. The convolution processing can be performed on the speech encoding result with added position encodings through a pointwise convolution, and an obtained convolution processing result can be passed and reshaped to obtain the speech feature matrix of the original dimension. The convolution processing can be performed on the speech feature matrix of the original dimension to obtain the speech feature matrix of the target dimension.

As an implementation, the extracting the speech features of the different pronunciation objects from the speech information sequence to obtain the speech feature sequence includes: performing a convolution processing on the speech information sequence to obtain the speech features of the different pronunciation objects; and performing a linear processing on the speech features of the different pronunciation objects to obtain the speech feature sequence.

In this embodiment, the convolution processing can be performed on the speech information sequence to obtain the speech features of the different pronunciation objects, where the speech features can represent the pronunciation attribute of the pronunciation object. The linear processing can be performed on the speech features of the different pronunciation objects to obtain the speech feature sequence.

In an implementation, the encoder may be composed of a one-dimension (1Dimension, 1D for short) convolution and a rectified linear unit (ReLU), where the rectified linear unit can be used to constrain an output speech feature sequence to be a non-negative value.

In an implementation, it can be assumed that a kernel size of the encoder is K₁, a step size is K_{1/2}, and the number of filters in the encoder can be N. Then, the speech information sequence (X) is input to the encoder, and the output speech feature sequence (X′) can be determined by the following formula:

$${X}^{′} = RELU ( Conv 1 D ( X ) )$$

where RELU can be a linear processing parameter; Conv 1D can be a one-dimension convolution parameter.

As an implementation, the acquiring the speech mask information of the different pronunciation objects based on the gated processing result includes: performing a linear processing on the gated processing result, and performing a convolution processing on an obtained linear processing result to obtain the speech mask information of the different pronunciation objects.

In this embodiment, the gated processing result can be acquired, a linear processing can be performed on the gated processing result, and the convolution processing can be performed on the linear processing result to obtain the speech mask information of the different pronunciation objects.

In an implementation, the gated processing result is acquired, and a rectification linear processing may be performed on the gated processing result, and a pointwise convolution processing may be performed on the linear processing result, so as to obtain the speech mask information of the different pronunciation objects.

As an implementation, the separating the speech information output by the different pronunciation objects from the speech information sequence based on the speech mask information of the different pronunciation objects and the speech feature sequence includes: acquiring a product result between the speech mask information of the different pronunciation objects and the speech feature sequence; and determining the product result as the speech information output by the different pronunciation objects.

In an embodiment of the present application, the speech mask information of the different pronunciation objects is acquired, and a product result between the speech mask information of the different pronunciation objects and the speech feature sequence is calculated, the product result can be determined as the speech information output by the different pronunciation objects.

In an implementation, the speech mask information (Mᵢ) of the different pronunciation objects and the speech feature sequence (X′) is acquired, the product result (Xᵢ″) of the speech mask information and the speech feature sequence is determined, and the product result can be determined as the speech information (Xᵢ″) output by the different pronunciation objects. The speech information output by the different pronunciation objects can be determined by the following formula:

$${X}_{i}^{″} = {M}_{i} * {X}^{′}$$

The embodiment of the present application performs the gated processing on the acquired speech features in the speech feature sequence according to the local attention mechanism and the global attention mechanism, and can obtain the local speech information and the global speech information of the different pronunciation objects. Based on the gated processing, a requirement of the local attention mechanism and the global attention mechanism is substantially reduced, so that not only global information can be directly processed, but also smaller local features can be processed, thereby realizing the technical effect of being able to perform a speech separation on the speech, and thereby solving the technical problem of being unable to perform a speech separation on the speech.

The following is a further introduction to a speech separation method under a scenario where a speech separation model is used.

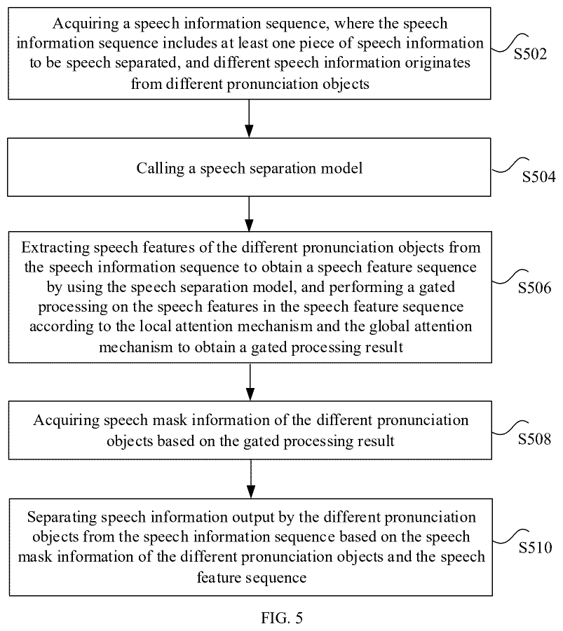

FIG. 5 is a flowchart of another speech separation method according to an embodiment of the present application. As shown in FIG. 5, the method may include the following steps.

Step S502, acquiring a speech information sequence, where the speech information sequence includes at least one piece of speech information to be speech separated, and different speech information originates from different pronunciation objects.

Step S504, calling a speech separation model, where the speech separation model is obtained by training based on a local attention mechanism and a global attention mechanism.

In the technical solution provided in the above step S504 of the present application, the speech information sequence is acquired, and the speech separation model can be called to process the speech information sequence to complete a speech separation in the speech information sequence. The speech separation model can be a model obtained by training based on the local attention mechanism and the global attention mechanism. For example, the speech separation model can be a deep neural network model obtained by training based on the local attention mechanism and the global attention mechanism.

In an implementation, the speech separation model can be a deep neural network model including an encoder, a decoder and a masker, and can be a model obtained by training based on a hybrid attention mechanism of the local attention mechanism and the global attention mechanism, and can be used to separate speech information from mixed speech information.

The embodiment of the present application proposes a deep network model algorithm based on an attention mechanism. Local data features can be modeled based on a model framework of a gated attention mechanism, and trained based on the local attention mechanism and the global attention mechanism to obtain the speech separation model. The speech separation model is obtained by training the local attention mechanism and the global attention mechanism, which not only simplifies the complexity of the algorithm, but also directly processes global information and processes smaller local features, thereby improving the effect of the speech separation on the speech, thereby better solving a speech separation problem.

Step S506, extracting speech features of the different pronunciation objects from the speech information sequence to obtain a speech feature sequence by using the speech separation model, and performing a gated processing on the speech features in the speech feature sequence according to the local attention mechanism and the global attention mechanism to obtain a gated processing result, where the gated processing result includes local speech information and global speech information of the different pronunciation objects, and an information granularity of the local speech information is smaller than an information granularity of the global speech information.

In the technical solution provided in the above step S506 of the present application, the speech separation model can be used to process the speech information sequence, and speech of the different pronunciation objects can be extracted from the speech information sequence. Features can be extracted from the speech information sequence, and the speech features of the different pronunciation objects can be extracted from the speech information sequence. The speech feature sequence can be obtained based on the speech features of the different pronunciation objects in the speech information sequence. The gated processing can be performed on the speech features in the speech feature sequence respectively according to the local attention mechanism and the global attention mechanism to obtain the gated processing result, where the gated processing result includes the local speech information and the global speech information of the different pronunciation objects, and the information granularity of the local speech information is smaller than the information granularity of the global speech information. The gated processing may include adding processing, multiplying processing, and others on the speech features.

In an implementation, speech information of at least one pronunciation object is acquired to obtain a speech information sequence, and features of speech information in the speech information sequence can be extracted by an encoder in the speech separation model to obtain the speech features of the different pronunciation objects, thereby obtaining the speech feature sequence. The gated processing can be performed on the speech features in the speech feature sequence according to the local attention mechanism and the global attention mechanism to obtain the gated processing result.

Step S508: acquiring speech mask information of the different pronunciation objects based on the gated processing result, where the speech mask information is used to represent a pronunciation attribute of the pronunciation object.

Step S510, separating speech information output by the different pronunciation objects from the speech information sequence based on the speech mask information of the different pronunciation objects and the speech feature sequence.

By means of the above steps S502 to S510 of the present application, a speech information sequence is acquired, where the speech information sequence includes at least one piece of speech information to be speech separated, and different speech information originates from different pronunciation objects; a speech separation model is called, where the speech separation model is obtained by training based on a local attention mechanism and a global attention mechanism; speech features of the different pronunciation objects are extracted from the speech information sequence to obtain a speech feature sequence by using the speech separation model, and a gated processing is performed on the speech features in the speech feature sequence according to the local attention mechanism and the global attention mechanism to obtain a gated processing result, where the gated processing result includes local speech information and global speech information of the different pronunciation objects, and an information granularity of the local speech information is smaller than an information granularity of the global speech information; speech mask information of the different pronunciation objects is acquired based on the gated processing result, where the speech mask information is used to represent a pronunciation attribute of the pronunciation object; and speech information output by the different pronunciation objects is separated from the speech information sequence based on the speech mask information of the different pronunciation objects and the speech feature sequence, which achieves the technical effect of being able to perform a speech separation on the speech, and solves the technical problem of being unable to perform the speech separation on the speech.

The following is a further introduction to a speech separation method under a speech playback scenario.

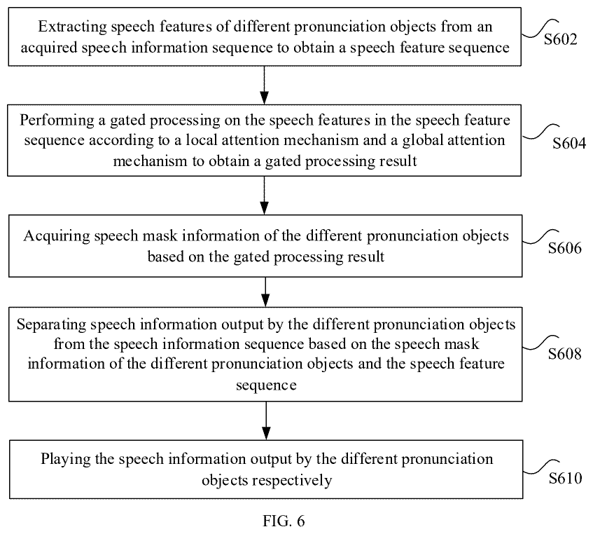

FIG. 6 is a flowchart of another speech separation method according to an embodiment of the present application.

As shown in FIG. 6, the method may include the following steps.

Step S602, extracting speech features of different pronunciation objects from an acquired speech information sequence to obtain a speech feature sequence, where the speech information sequence includes at least one piece of speech information to be speech separated, and different speech information originates from the different pronunciation objects.

Step S604, performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

Step S606: acquiring speech mask information of the different pronunciation objects based on the gated processing result, where the speech mask information is used to represent a pronunciation attribute of the pronunciation object.

Step S608, separating speech information output by the different pronunciation objects from the speech information sequence based on the speech mask information of the different pronunciation objects and the speech feature sequence.

Step S610, playing the speech information output by the different pronunciation objects respectively.

By means of the above steps S602 to S610 of the present application, speech features of different pronunciation objects are extracted from an acquired speech information sequence to obtain a speech feature sequence, where the speech information sequence includes at least one piece of speech information to be speech separated, and different speech information originates from the different pronunciation objects; a gated processing on the speech features in the speech feature sequence is performed according to a local attention mechanism and a global attention mechanism to obtain a gated processing result, where the gated processing result includes local speech information and global speech information of the different pronunciation objects, and an information granularity of the local speech information is smaller than an information granularity of the global speech information; speech mask information of the different pronunciation objects is acquired based on the gated processing result, where the speech mask information is used to represent a pronunciation attribute of the pronunciation object; speech information output by the different pronunciation objects is separated from the speech information sequence based on the speech mask information of the different pronunciation objects and the speech feature sequence; and the speech information output by the different pronunciation objects is played respectively, which achieves the technical effect of being able to perform a speech separation on the speech, and solves the technical problem of being unable to perform the speech separation on the speech.

The following is a further introduction to a speech separation method under a speech recognition scenario.

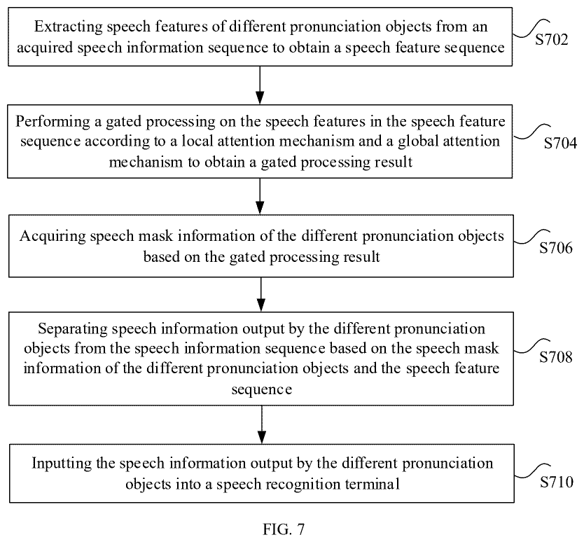

FIG. 7 is a flowchart of another speech separation method according to an embodiment of the present application. As shown in FIG. 7, the method may include the following steps.

Step S702, extracting speech features of different pronunciation objects from an acquired speech information sequence to obtain a speech feature sequence, where the speech information sequence includes at least one piece of speech information to be speech separated, and different speech information originates from the different pronunciation objects.

Step S704, performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

Step S706: acquiring speech mask information of the different pronunciation objects based on the gated processing result, where the speech mask information is used to represent a pronunciation attribute of the pronunciation object.

Step S708, separating speech information output by the different pronunciation objects from the speech information sequence based on the speech mask information of the different pronunciation objects and the speech feature sequence.

Step S710, inputting the speech information output by the different pronunciation objects into a speech recognition terminal, where the speech information is used to be recognized by the speech recognition terminal.

In the technical solution provided in the above step S710 of the present application, the speech information output by the different pronunciation objects obtained can be input into the speech recognition terminal, the speech recognition terminal can recognize the speech information, and the speech recognition terminal can perform a response processing based on a recognition result.

For example, the speech recognition terminal can be an intelligent speech assistant. When the speech recognition terminal recognizes speech information emitted by an owner from the speech information output by the different pronunciation objects, it can recognize contents in the speech information of the owner and take a corresponding action. For example, if the speech information of the owner is “open music player”, then after the speech recognition terminal recognize the speech information of the owner, the speech recognition terminal can execute instruction to open the music player.

It should be noted that the above scenario is only an example. No specific restrictions are made on the speech recognition terminal, nor on a usage scenario of a speech separation method. Scenarios with a speech separation should be within the protection scope of embodiments of the present application.

By means of the above steps S702 to S710 of the present application, speech features of different pronunciation objects are extracted from an acquired speech information sequence to obtain a speech feature sequence, where the speech information sequence includes at least one piece of speech information to be speech separated, and different speech information originates from the different pronunciation objects; a gated processing is performed on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; speech mask information of the different pronunciation objects is acquired based on the gated processing result, where the speech mask information is used to represent a pronunciation attribute of the pronunciation object; speech information output by the different pronunciation objects is separated from the speech information sequence based on the speech mask information of the different pronunciation objects and the speech feature sequence; and the speech information output by the different pronunciation objects is inputted into a speech recognition terminal, where the speech information is used to be recognized by the speech recognition terminal, which achieves the technical effect of being able to perform a speech separation on the speech, and solves the technical problem of being unable to perform the speech separation on the speech.

An embodiment of the present application also provides another speech separation method, which can be applied to a software service side (SaaS).

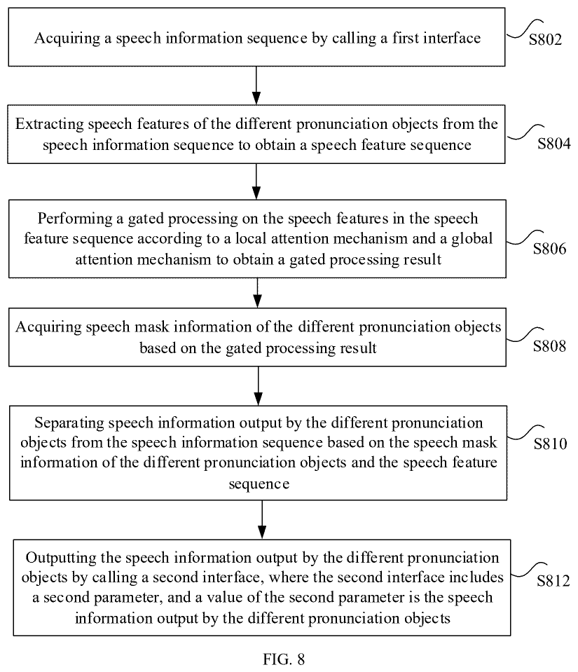

FIG. 8 is a flowchart of another speech separation method according to an embodiment of the present application.

Step S802, acquiring a speech information sequence by calling a first interface, where the first interface includes a first parameter, a parameter value of the first parameter is the voice information sequence, the speech information sequence includes at least one piece of speech information to be speech separated, and different speech information originates from different pronunciation objects.

In the technical solution provided in the above step S802 of the present application, the first interface can be an interface for data interaction between a server and a user terminal. The user terminal can acquire the speech information sequence by calling the first interface. The speech information sequence is used as the first parameter of the first interface to achieve a purpose of acquiring the speech information sequence, where the speech information sequence may include the at least one speech information to be speech separated, and the different speech information may originate from the different pronunciation objects.

Step S804: extracting speech features of the different pronunciation objects from the speech information sequence to obtain a speech feature sequence.

Step S806, performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

Step S808: acquiring speech mask information of the different pronunciation objects based on the gated processing result, where the speech mask information is used to represent a pronunciation attribute of the pronunciation object.

Step S810, separating speech information output by the different pronunciation objects from the speech information sequence based on the speech mask information of the different pronunciation objects and the speech feature sequence.

Step S812: outputting the speech information output by the different pronunciation objects by calling a second interface, where the second interface includes a second parameter, and a value of the second parameter is the speech information output by the different pronunciation objects.

In the technical solution provided in the above step S812 of the present application, the second interface can be an interface for data interaction between a server and a user terminal. The server can send the speech information output by different pronunciation objects to a client, so that the client can output the speech information output by different pronunciation objects to the second interface as a parameter of the second interface, thereby achieving a purpose of sending the speech information to the user terminal.

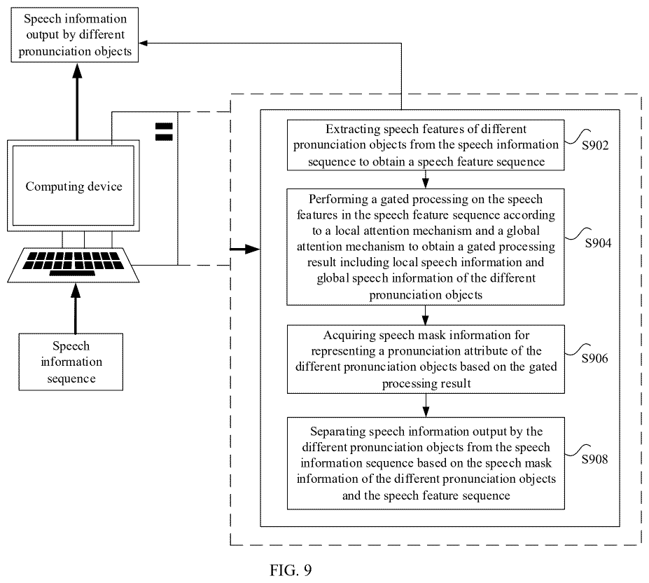

FIG. 9 is a schematic diagram of an accessing to a private network by a computer device according to an embodiment of the present application. As shown in FIG. 9, a speech information sequence can be acquired by calling a first interface, and the computer device executes: step S902, extracting speech features of different pronunciation objects from the speech information sequence to obtain a speech feature sequence; step S904, performing a gated processing on the speech features in the speech feature sequence according to a local attention mechanism and a global attention mechanism to obtain a gated processing result including local speech information and global speech information of the different pronunciation objects; step S906, acquiring speech mask information for representing a pronunciation attribute of the different pronunciation objects based on the gated processing result; step S908, separating speech information output by the different pronunciation objects from the speech information sequence based on the speech mask information of the different pronunciation objects and the speech feature sequence; and outputting the speech information output by the different pronunciation objects by calling a second interface.

In an implementation, a platform can output the speech information output by the different pronunciation objects by calling a second interface, where the second interface can be configured to send a target domain name to a client, so that the client sends the speech information output by the different pronunciation objects.

The embodiment of the present application, by acquiring a speech information sequence by calling a first interface, where the first interface includes a first parameter, a parameter value of the first parameter is the voice information sequence, the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and outputting the speech information output by the different pronunciation objects by calling a second interface, where the second interface includes a second parameter, and a value of the second parameter is the speech information output by the different pronunciation objects, achieves the technical effect of being able to perform a speech separation on the speech, thereby solving the technical problem of being unable to perform a speech separation on the speech.

### Embodiment 2

A speech separation can separate a single speech source from overlapping mixed speech. When multiple people are communicating at the same time, if a speech separation is not performed after collecting by a microphone, it will directly affect a speech recognition system or the auditory perception and the comprehension. Therefore, in order to improve the recognition effect and the auditory experience, mixed speech of multiple speakers is usually separated by a speech separation to obtain a separation result, which can be used as an input signal for a speech recognition or directly played to a listener.

In related art, a speech separation model (Wavesplit model) is proposed to achieve a terminal-to-terminal speech separation through speaker clustering, which uses a label of speech content of an additional people during training, thereby increasing the training cost. Moreover, the method is only based on a convolutional network and still has a problem of being unable to process global information of a speech information sequence.

In another related art, a speech separation (SepFormer) model is proposed. Although this model uses a multi-head attention mechanism, the method only processes a long speech information sequence by cutting a long sequence into short sequences, and then performs an attention processing within and between sequences. A global processing manner is only through an implicit non-direct interaction, and there is still a problem of being unable to process global information of the speech information sequence. In addition, the method also has a technical problem of low efficiency in speech separation.

To solve the above problems, an embodiment of the present application proposes a deep network model algorithm based on the attention mechanism. Local data features can be modeled based on a model framework of a gated attention mechanism, which not only simplifies the complexity of the algorithm, but also directly processes global information and processes smaller local features, thereby improving the effect of the speech separation on the speech, thereby better solving a speech separation problem.

The following is a further introduction to a deep network model algorithm based on an attention mechanism proposed in an embodiment of the present application.

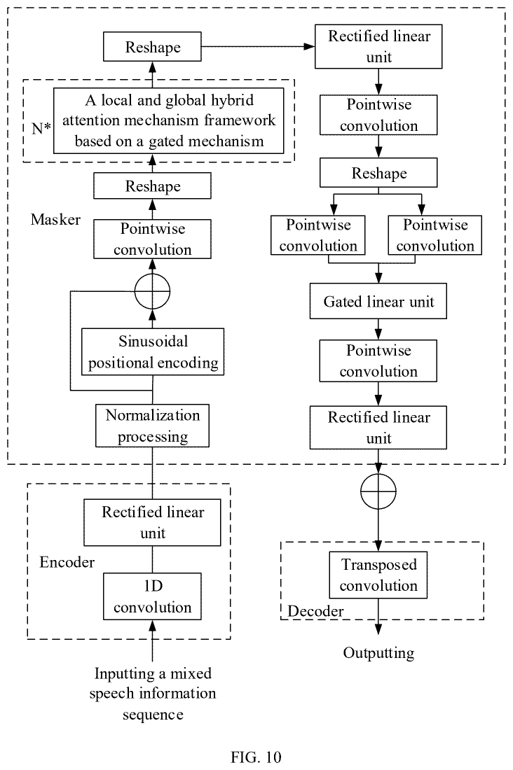

FIG. 10 is a schematic diagram of a deep network model based on an attention mechanism according to an embodiment of the present application. As shown in FIG. 10, a deep network model (MOSSFORMER model) based on an attention mechanism may include an encoder, a decoder and a masker (Masking Net). Where the encoder and the decoder can be used for extracting features from speech information and reconstructing waveforms respectively, and the masker is used to map output of the encoder into a set of masks.

In this embodiment, as shown in FIG. 10, a mixed speech information sequence (Mixture) is acquired and the mixed speech information sequence is input into the encoder, where the encoder may be composed of a one-dimension convolution and a rectified linear unit, where the rectified linear unit can be used to constrain an output speech feature sequence to be a non-negative value.

In an implementation, it can be assumed that a kernel size of the encoder is K₁, the step size is K_{1/2}, and the number of filters in the encoder can be N. Then, the speech information sequence (X) is input to the encoder, and the output speech feature sequence (X′) can be determined by the following formula:

$${X}^{′} = RELU ( Conv 1 D ( X ) )$$

In an implementation, the sequence X′ can be element wise multiplied by a mask (Mᵢ) of each speaker, so that a separated feature sequence (Xᵢ″) can be obtained, and the feature sequence (Xᵢ″) can be determined by the following formula:

$${X}_{i}^{″} = {M}_{i} * {X}^{′}$$

The separated feature sequence can finally be decoded by the one-dimension transposed convolution (1D Transposed Convolution) in the decoder to obtain a speech information sequence of each pronunciation object, where the speech information sequence of each pronunciation object can be represented by a separated waveform (Separated Source), the separated waveform ( [symbol] ) can be represented by the following method:

$$= Transposed - ConvID ( {X}_{i}^{″} )$$

In an implementation, the decoder can be a one-bit transposed convolution, and a decoder with the same kernel size and stride as the encoder can be used.

In this embodiment, as shown in FIG. 10, the masker can be used to perform a non-linear mapping on the speech information sequence (X′) output by the encoder.

In an implementation, as shown in FIG. 10, a speech information sequence output by an encoder may first pass through a linear layer and be normalized to obtain a normalized speech result, and position encodings may be added to the normalized speech result. The sequence with added position encodings may be passed through a pointwise convolution and reshaped, and after reshaping, the sequence may be passed to a local and global hybrid attention mechanism framework (MossFormer Block) based on a gated mechanism for processing. A result obtained after processing by the local and global hybrid attention mechanism framework based on a gated mechanism can be output to a rectified linear unit for another pointwise convolution, and a dimension of the obtained sequence RN*S can be extended to RC*N*S. A masked speech information sequence (M) can be obtained by performing pointwise convolution and gated linear unit (GLU) in parallel, followed by one more pointwise convolution and a rectified linear unit. For each speaker, there is a corresponding masked speech information sequence, and then the masked speech information sequence corresponding to each speaker is output to the decoder for processing.

In this embodiment, as shown in FIG. 10, N local and global hybrid attention mechanism frameworks based on a gated mechanism may be set up for input and output to facilitate training, and a current output of the local and global hybrid attention mechanism framework based on the gated mechanism may be transmitted as input to a next local and global hybrid attention mechanism framework based on the gated mechanism, until the last local and global hybrid attention mechanism framework based on the gated mechanism outputs processed data to a rectified linear unit.

In this embodiment, the speech information sequence can be processed by a convolution module and an attention gated mechanism. The convolution module can use a linear projection and a depth wise convolution processing. The attention gated mechanism can include a local attention mechanism, a global attention mechanism and a gated operation. The convolutional module and the gated structure are used to improve the modeling capability of the local and global hybrid attention mechanism framework based on the gated mechanism. The use of the gated structure effectively promotes a joint attention of local and global.

FIG. 11 is a schematic diagram of a local and global hybrid attention mechanism framework based on a gated mechanism according to an embodiment of the present application. As shown in FIG. 11, the local and global hybrid attention mechanism framework based on the gated mechanism may include a convolution module, an offset, time scaling and rope module (Scale&Offset&Rope), a local and global single-head attention module (Local&Globat&Joint&Attention) and a gated operation module.

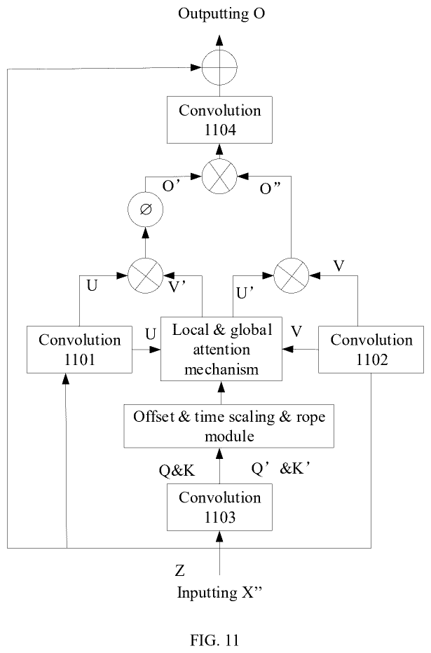

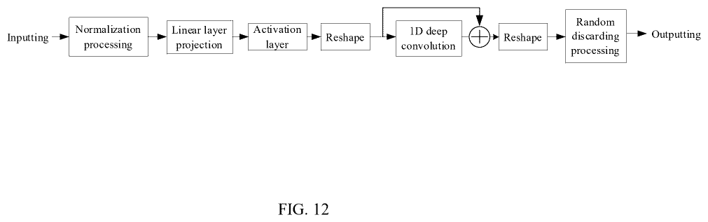

In an embodiment of the present application, a dense layer in a gated attention unit (GAU) can be replaced by a convolution module, thereby improving the efficiency of extracting fine-grained local features. FIG. 12 is a schematic diagram of a convolution module according to an embodiment of the present application. As shown in FIG. 12, a convolution module can normalize and project an input speech information sequence through a linear layer, perform a linear processing on normalized data through an activation layer (SiLU Activation), perform a feature convolution on the sequence through a one-dimensional deep convolution, and perform a random discarding processing (Dropout) on data after feature convolution to complete the training and regularization of the convolution module.

In an implementation, the gated operation module can be triple-gated to enhance the model capability. It should be noted that there is no specific restriction on the number of “gates” in the gated module. As shown in FIG. 11, input (X″) of the local and global hybrid attention mechanism framework based on the gated mechanism can be acquired, and convolution processing results (U and V) are obtained after being processed by a convolution 1101 and a convolution 1102 respectively. The convolution processing results can be determined by the following formulas:

$$U = C o n v M ( {X}^{″} )$$

$$V = Co n v M ( {X}^{′} )$$

where ConvM can be used to represent a convolution module. Speech features can be converted from N-dimension to a 2N-dimension speech feature matrix through a convolution. A processing result of the convolution can be processed by the gated operation module to obtain gated processing results (O′, O″, O).

$${O}^{′} = ∅ ( U ⊗ {V}^{′} )$$

$${O}^{″} = {V}^{′} ⊗ {U}^{′}$$

$$O = {X}^{″} + ConvM ( {O}^{′} ⊗ {O}^{″} )$$

In this embodiment, the requirement for the attention mechanism can be greatly reduced by performing the gated processing, thereby achieving a purpose of simplifying the multi-head attention mechanism into a single-head attention mechanism, thereby greatly reducing the requirement for the local attention mechanism and the global attention mechanism.

In an implementation, for a long sentence, a data processing process takes a long time. Therefore, in the embodiment of the present application, a gated operation module can be used to combine the local speech feature matrix (U) and the global speech feature matrix (V) in an efficient and effective manner, thereby improving the efficiency of the model in data processing.

In this embodiment, a hybrid attention mechanism framework can be used. In a local attention mechanism, we only use the single-head attention mechanism. A simplified linear attention mechanism can be used for the global attention mechanism, and the single-head attention mechanism can be used for the local attention mechanism.

In an implementation, as shown in FIG. 11, an input sentence (X″) may be acquired first, and X″ can be processed by a convolution 1103 to obtain a shared representation Z, which may be calculated by the following formula:

$$Z = C o n v M ( {X}^{″} )$$

As shown in FIG. 11, Z output from the convolution can be acquired through a rope module in the offset, time scaling and rope module, and Z can be shared, so that a query word Q and a key K of local and global can be acquired. In order to use a global linear attention mechanism, global speech information of the speech feature matrix V and the speech feature matrix U can be described in the following linearized forms:

$${V}_{{global}^{′}} = {Q}^{′} ( β {K}^{′ T} V ) , {U}_{{global}^{′}} = {Q}^{′} ( β {K}^{′ T} U )$$

where β can be a time scaling coefficient.

In an implementation, in order to calculate the local attention, V, U, Q and K can be divided into H non-overlapping blocks with size P using zero padding, and the divided non-overlapping blocks can be converted according to the single-head attention mechanism to obtain local speech information (V_{local,h′} and U_{local,h′}), which can be determined by the following formula:

$${V}_{local , h}^{′} = {RELU}^{2} ( γ {Q}_{h} {K}_{h}^{T} ) {V}_{h} , {U}_{local , h}^{′} = {RELU}^{2} ( γ {Q}_{h} {K}_{h}^{T} ) {U}_{h}$$

where γ can be a scaling coefficient.

In this embodiment, a squared rectified linear coefficient (RELU²) is used to replace a normalized exponential function (Softmax) in the multi-head attention mechanism (Multi-Head Attention), thereby further optimizing the model performance.

In an implementation, the global speech information and the local speech information can be added together to form a final joint attention of V′ and sequence U′:

$${V}^{′} = {V}_{global}^{′} + {V}_{local}^{′} , {U}^{′} = {U}_{global}^{′} + {U}_{local}^{′}$$

In an embodiment of the present application, in order to better improve an attention mechanism modeling capability of a long sequence, the local and global hybrid attention mechanism framework based on the gated mechanism is proposed. The gated mechanism can greatly reduce the requirement for the attention mechanism, and can simplify the multi-head attention mechanism to the single-head attention mechanism, thereby greatly reducing the requirement for the local attention mechanism and the global attention mechanism. In the local attention mechanism, only the single-head attention mechanism can be used, thereby achieving a purpose of significantly reducing the amount of computation. At the same time, a simplified linear attention mechanism can be used in the global attention mechanism to achieve the purpose, thereby greatly simplifying the complexity of the algorithm and directly processing global information.

The attention mechanism mainly processes global information, and does not do much processing on smaller local features, and cannot effectively extract features of short-term changes in speech. In order to make up for this deficiency, an embodiment of the present application also proposes a convolution processing module, which uses a deep convolution to extract local features, by combining the convolution processing module and the gated-based attention mechanism, achieves the technical effect of being able to perform a speech separation on the speech, and thereby solving the technical problem of being unable to perform a speech separation on the speech.

It should be noted that, for a sake of simplicity of description, the above method embodiments are all expressed as a series of action combinations, but those skilled in the art should aware that the present application is not limited to the described order of actions, since according to the present application, certain steps can be performed in other orders or simultaneously. In addition, those skilled in the art should also be aware that the embodiments described in the specification are all preferred embodiments, and the actions and modules involved are not necessarily required by the present application.

Through the description of the above implementations, those skilled in the art can clearly understand that the method according to the above embodiment can be implemented by means of software plus a necessary general hardware platform, and of course by hardware, but in many cases the former is a better implementation. Based on this understanding, the technical solution of the present application can essentially or the part that contributes to the prior art can be embodied in the form of a software product. The computer software product is stored in a storage medium (such as a ROM/RAM, a disk, a compact disc read-only memory (CD-ROM)), and includes a number of instructions for enabling a terminal device (which can be a mobile phone, a computer, a server, or a network device, etc.) to execute a method of each embodiment of the present application.

### Embodiment 3

According to an embodiment of the present application, a speech separation apparatus for implementing the speech separation method shown in FIG. 4 is also provided.

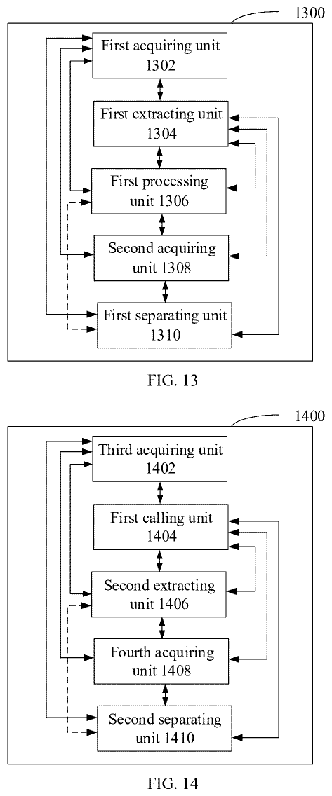

FIG. 13 is a schematic diagram of a speech separation apparatus according to an embodiment of the present application. As shown in FIG. 13, the speech separation apparatus 1300 may include: a first acquiring unit 1302, a first extracting unit 1304, a first processing unit 1306, a second acquiring unit 1308 and a first separating unit 1310.

The first acquiring unit 1302 is configured to acquire a speech information sequence, where the speech information sequence includes at least one piece of speech information to be speech separated, and different speech information originates from different pronunciation objects.

The first extracting unit 1304 is configured to extract speech features of the different pronunciation objects from the speech information sequence to obtain a speech feature sequence.

The first processing unit 1306 is configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

The second acquiring unit 1308 is configured to acquire speech mask information of the different pronunciation objects based on the gated processing result, where the speech mask information is used to represent a pronunciation attribute of the pronunciation object.

The first separating unit 1310 is configured to separate speech information output by the different pronunciation objects from the speech information sequence based on the speech mask information of the different pronunciation objects and the speech feature sequence.

It should be noted here that the above first acquiring unit 1302, the first extracting unit 1304, the first processing unit 1306, the second acquiring unit 1308 and the first separating unit 1310 correspond to steps S402 to S410 in Embodiment 1, and the five units have the same instances and application scenarios implemented by the corresponding steps, but are not limited to the contents disclosed in the above-Embodiment 1. It should be noted that the above units can be a hardware component or a software component stored in a memory (e.g., the memory 104) and processed by one or more processors (e.g., the processors 102a, 102b, . . . , 102n), and the above units can also be run as part of the apparatus in a computer terminal 10 provided in Embodiment 1.

According to an embodiment of the present application, a speech separation apparatus for implementing the speech separation method shown in FIG. 5 is also provided.

FIG. 14 is a schematic diagram of another speech separation apparatus according to an embodiment of the present application. As shown in FIG. 14, the speech separation apparatus 1400 may include: a third acquiring unit 1402, a first calling unit 1404, a second extracting unit 1406, a fourth acquiring unit 1408 and a second separating unit 1410.

The third acquiring unit 1402 is configured to acquire a speech information sequence, where the speech information sequence includes at least one piece of speech information to be speech separated, and different speech information originates from different pronunciation objects.

The first calling unit 1404 is configured to call a speech separation model, where the speech separation model is obtained by training based on a local attention mechanism and a global attention mechanism.

The second extracting unit 1406 is configured to extract speech features of the different pronunciation objects from the speech information sequence to obtain a speech feature sequence by using the speech separation model, and perform a gated processing on the speech features in the speech feature sequence according to the local attention mechanism and the global attention mechanism to obtain a gated processing result, where the gated processing result includes local speech information and global speech information of the different pronunciation objects, and an information granularity of the local speech information is smaller than an information granularity of the global speech information.

The fourth acquiring unit 1408 is configured to acquire speech mask information of the different pronunciation objects based on the gated processing result, where the speech mask information is used to represent a pronunciation attribute of the pronunciation object.

The second separating unit 1410 is configured to separate speech information output by the different pronunciation objects from the speech information sequence based on the speech mask information of the different pronunciation objects and the speech feature sequence.

It should be noted here that the above third acquiring unit 1402, the first calling unit 1404, the second extracting unit 1406, the fourth acquiring unit 1408 and the second separating unit 1410 correspond to steps S502 to S510 in Embodiment 1, and the five units have the same instances and application scenarios implemented by the corresponding steps, but are not limited to the contents disclosed in the above-Embodiment 1. It should be noted that the above units can be a hardware component or a software component stored in a memory (e.g., the memory 104) and processed by one or more processors (e.g., the processors 102a, 102b, . . . , 102n), and the above units can also be run as part of the apparatus in a computer terminal 10 provided in Embodiment 1.

According to an embodiment of the present application, a speech separation apparatus for implementing the speech separation method shown in FIG. 6 is also provided.

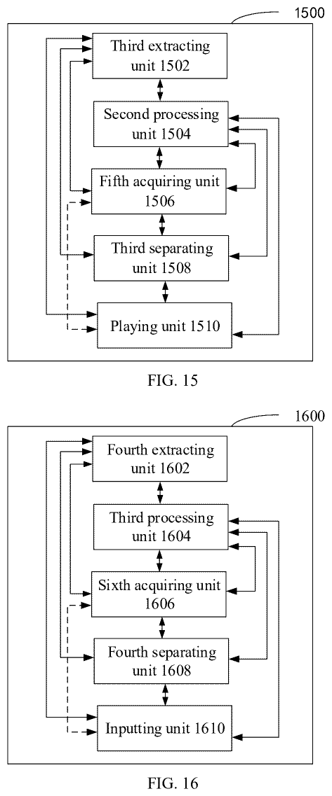

FIG. 15 is a schematic diagram of another speech separation apparatus according to an embodiment of the present application. As shown in FIG. 15, the speech separation apparatus 1500 may include: a third extracting unit 1502, a second processing unit 1504, a fifth acquiring unit 1506, a third separating unit 1508 and a playing unit 1510.

The third extracting unit 1502 is configured to extract speech features of different pronunciation objects from an acquired speech information sequence to obtain a speech feature sequence, where the speech information sequence includes at least one piece of speech information to be speech separated, and different speech information originates from the different pronunciation objects.

The second processing unit 1504 is configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

The fifth acquiring unit 1506 is configured to acquire speech mask information of the different pronunciation objects based on the gated processing result, where the speech mask information is used to represent a pronunciation attribute of the pronunciation object.

The third separating unit 1508 is configured to separate speech information output by the different pronunciation objects from the speech information sequence based on the speech mask information of the different pronunciation objects and the speech feature sequence.

The playing unit 1510 is configured to play the speech information output by the different pronunciation objects respectively.

It should be noted here that the above third extracting unit 1502, the second processing unit 1504, the fifth extracting unit 1506, the third separating unit 1508 and the playing unit 1510 correspond to steps S602 to S610 in Embodiment 1, and the five units have the same instances and application scenarios implemented by the corresponding steps, but are not limited to the contents disclosed in the above-Embodiment 1. It should be noted that the above units can be a hardware component or a software component stored in a memory (e.g., the memory 104) and processed by one or more processors (e.g., the processors 102a, 102b, . . . , 102n), and the above units can also be run as part of the apparatus in a computer terminal 10 provided in Embodiment 1.

According to an embodiment of the present application, a speech separation apparatus for implementing the speech separation method shown in FIG. 7 is also provided, and the apparatus can be applied in a scenario of speech playback.

FIG. 16 is a schematic diagram of another speech separation apparatus according to an embodiment of the present application. As shown in FIG. 16, the speech separation apparatus 1600 may include: a fourth extracting unit 1602, a third processing unit 1604, a sixth acquiring unit 1606, a fourth separating unit 1608 and an inputting unit 1610.

The fourth extracting unit 1602 is configured to extract speech features of different pronunciation objects from an acquired speech information sequence to obtain a speech feature sequence, where the speech information sequence includes at least one piece of speech information to be speech separated, and different speech information originates from the different pronunciation objects.

The third processing unit 1604 is configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

The sixth acquiring unit 1606 is configured to acquire speech mask information of the different pronunciation objects based on the gated processing result, where the speech mask information is used to represent a pronunciation attribute of the pronunciation object.

The fourth separating unit 1608 is configured to separate speech information output by the different pronunciation objects from the speech information sequence based on the speech mask information of the different pronunciation objects and the speech feature sequence.

The inputting unit 1610 is configured to input the speech information output by the different pronunciation objects into a speech recognition terminal, where the speech information is used to be recognized by the speech recognition terminal.

It should be noted here that the above fourth extracting unit 1602, the third processing unit 1604, the sixth acquiring unit 1606, the fourth separating unit 1608 and the inputting unit 1610 correspond to steps S702 to S710 in Embodiment 1, and the five units have the same instances and application scenarios implemented by the corresponding steps, but are not limited to the contents disclosed in the above-Embodiment 1. It should be noted that the above units can be a hardware component or a software component stored in a memory (e.g., the memory 104) and processed by one or more processors (e.g., the processors 102a, 102b, . . . , 102n), and the above units can also be run as part of the apparatus in a computer terminal 10 provided in Embodiment 1.

According to an embodiment of the present application, a speech separation apparatus for implementing the speech separation method shown in FIG. 8 is also provided, and the apparatus can be applied in a speech recognition scenario.

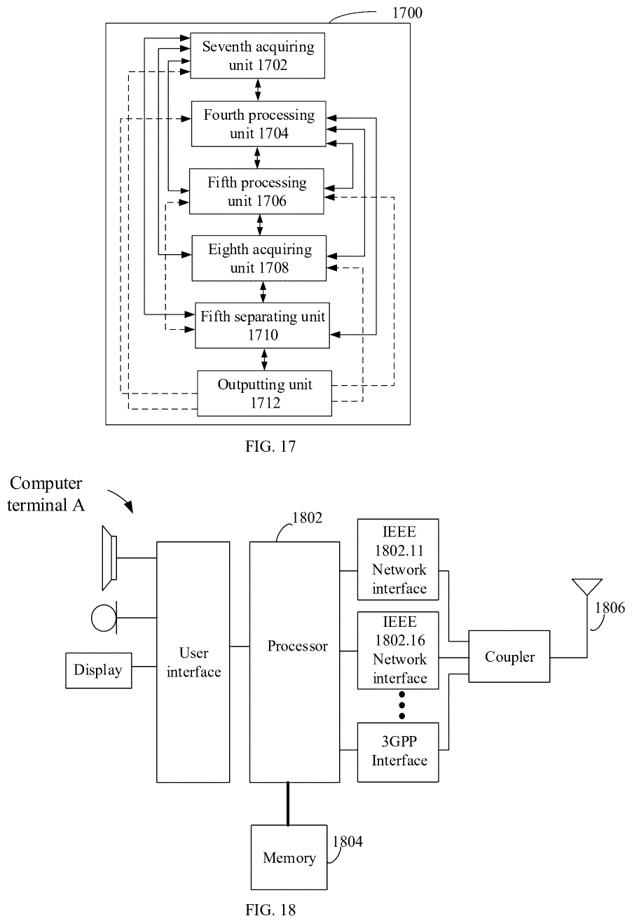

FIG. 17 is a schematic diagram of another speech separation apparatus according to an embodiment of the present application. As shown in FIG. 17, the speech separation apparatus 1700 may include: a seventh acquiring unit 1702, a fourth processing unit 1704, a fifth processing unit 1706, an eighth acquiring unit 1708, a fifth separating unit 1710 and an outputting unit 1712.

The seventh acquiring unit 1702 is configured to acquire a speech information sequence by calling a first interface, where the first interface includes a first parameter, a parameter value of the first parameter is the voice information sequence, the speech information sequence includes at least one piece of speech information to be speech separated, and different speech information originates from different pronunciation objects.

The fourth processing unit 1704 is configured to extract speech features of the different pronunciation objects from the speech information sequence to obtain a speech feature sequence.

The fifth processing unit 1706 is configured to perform a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information.

The eighth acquiring unit 1708 is configured to acquire speech mask information of the different pronunciation objects based on the gated processing result, where the speech mask information is used to represent a pronunciation attribute of the pronunciation object.

The fifth separating unit 1710 is configured to separate speech information output by the different pronunciation objects from the speech information sequence based on the speech mask information of the different pronunciation objects and the speech feature sequence.

The outputting unit 1712 is configured to output the speech information output by the different pronunciation objects by calling a second interface, where the second interface includes a second parameter, and a value of the second parameter is the speech information output by the different pronunciation objects.

It should be noted here that the above seventh acquiring unit 1702, the fourth processing unit 1704, the fifth processing unit 1706, the eighth acquiring unit 1708, the fifth separating unit 1710 and the outputting unit 1712 correspond to steps S802 to S812 in Embodiment 1, and the five units have the same instances and application scenarios implemented by the corresponding steps, but are not limited to the contents disclosed in the above Embodiment 1. It should be noted that the above units can be a hardware component or a software component stored in a memory (e.g., the memory 104) and processed by one or more processors (e.g., the processors 102a, 102b, . . . , 102n), and the above units can also be run as part of the apparatus in a computer terminal 10 provided in Embodiment 1.

The speech separation apparatus of the embodiment performs the gated processing on the acquired speech features in the speech feature sequence according to the local attention mechanism and the global attention mechanism, and can obtain the local speech information and the global speech information of the different pronunciation objects. Based on the gated processing, a requirement of the local attention mechanism and the global attention mechanism is substantially reduced, so that not only global information can be directly processed, but also smaller local features can be processed, thereby realizing the technical effect of being able to perform a speech separation on the speech, and thereby solving the technical problem of being unable to perform a speech separation on the speech.

### Embodiment 4

An embodiment of the present application may provide a processor, which may include a computer terminal, and the computer terminal may be any computer terminal device in a computer terminal group. In this embodiment, the computer terminal may also be replaced by a terminal device such as a mobile terminal.

In this embodiment, the computer terminal may be located in at least one network device among a plurality of network devices of a computer network.

In this embodiment, the above computer terminal can execute program codes of following steps in a speech separation method of an application: acquiring a speech information sequence, where the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; and separating speech information output by the different pronunciation objects from the speech information sequence based on the speech mask information of the different pronunciation objects and the speech feature sequence.

In an implementation, FIG. 18 is a structure block diagram of a computer terminal according to an embodiment of the present application. As shown in FIG. 18, a computer terminal A may include: one or more (only one is shown in the figure) processors 1802, a memory 1804, and a transmission apparatus 1806.

The memory can be configured to store software programs and modules, such as program instructions/modules corresponding to speech separation methods and apparatus in embodiments of the present application. The processor executes various functional applications and predictions by running the software programs and modules stored in the memory, that is, the above speech separation methods are implemented. The memory may include a high-speed random access memory and may also include a non-volatile memory, such as one or more magnetic storage apparatuses, flash memories, or other non-volatile solid-state memories. In some examples, the memory may further include memories remotely located relative to the processor, and these remote memories may be connected to the computer terminal A via a network. Examples of the above network include but are not limited to an internet, an intranet, a local area network, a mobile communication network and a combination thereof.

The processor can call information and an application stored in the memory through the transmission apparatus to perform the following steps: acquiring a speech information sequence, where the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; and separating speech information output by the different pronunciation objects from the speech information sequence based on the speech mask information of the different pronunciation objects and the speech feature sequence.

In an implementation, the processor may also execute program codes of the following steps: converting the speech features in the speech feature sequence according to a single-head attention mechanism to obtain the local speech information; converting the speech features in the speech feature sequence according to a linear attention mechanism to obtain the global speech information; and performing the gated processing on the local speech information and the global speech information to obtain the gated processing result.

In an implementation, the processor may also execute program codes of the following steps: performing a convolution processing on the speech features in the speech feature sequence to obtain a speech feature matrix of a target dimension; and converting the speech feature matrix according to the linear attention mechanism to obtain the global speech information.

In an implementation, the processor may also execute program codes of the following steps: converting a blocked speech feature matrix of the speech feature matrix according to the single-head attention mechanism to obtain the local speech information.

In an implementation, the processor may also execute program codes of the following steps: acquiring combined speech information between the global speech information and the local speech information; and performing the gated processing on the combined speech information, the speech feature matrix and the speech feature sequence to obtain the gated processing result.

In an implementation, the processor may also execute program codes of the following steps: performing the convolution processing on the speech features in the speech feature sequence for multiple times to obtain speech feature matrices of different target dimensions.

In an implementation, the processor may also execute program codes of the following steps: performing a normalization processing on the speech feature sequence to obtain a normalized speech result; encoding the normalized speech result to obtain a speech encoding result; performing a convolution processing on the speech encoding result, and converting an obtained convolution result to obtain a speech feature matrix of an original dimension; and performing a convolution processing on the speech feature matrix of the original dimension to obtain the speech feature matrix of the target dimension.

In an implementation, the processor may also execute program codes of the following steps: performing a convolution processing on the speech information sequence to obtain the speech features of the different pronunciation objects; and performing a linear processing on the speech features of the different pronunciation objects to obtain the speech feature sequence.

In an implementation, the processor may also execute program codes of the following steps: performing a linear processing on the gated processing result, and performing a convolution processing on an obtained linear processing result to obtain the speech mask information of the different pronunciation objects.

In an implementation, the processor may also execute program codes of the following steps: acquiring a product result between the speech mask information of the different pronunciation objects and the speech feature sequence; and determining the product result as the speech information output by the different pronunciation objects.

As an example, the processor can call information and an application stored in the memory through the transmission apparatus to perform the following steps: acquiring a speech information sequence, where the speech information sequence includes at least one piece of speech information to be speech separated, and different speech information originates from different pronunciation objects; calling a speech separation model, where the speech separation model is obtained by training based on a local attention mechanism and a global attention mechanism; extracting speech features of the different pronunciation objects from the speech information sequence to obtain a speech feature sequence by using the speech separation model, and performing a gated processing on the speech features in the speech feature sequence according to the local attention mechanism and the global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; and separating speech information output by the different pronunciation objects from the speech information sequence based on the speech mask information of the different pronunciation objects and the speech feature sequence.

As an example, the processor can call information and an application stored in the memory through the transmission apparatus to perform the following steps: extracting speech features of different pronunciation objects from an acquired speech information sequence to obtain a speech feature sequence, where the speech information sequence includes at least one piece of speech information to be speech separated, and different speech information originates from the different pronunciation objects; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and playing the speech information output by the different pronunciation objects respectively.

As an example, the processor can call information and an application stored in the memory through the transmission apparatus to perform the following steps: extracting speech features of different pronunciation objects from an acquired speech information sequence to obtain a speech feature sequence, where the speech information sequence includes at least one piece of speech information to be speech separated, and different speech information originates from the different pronunciation objects; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and inputting the speech information output by the different pronunciation objects into a speech recognition terminal, where the speech information is used to be recognized by the speech recognition terminal.

As an example, the processor can call information and an application stored in the memory through the transmission apparatus to perform the following steps: acquiring a speech information sequence by calling a first interface, where the first interface includes a first parameter, a parameter value of the first parameter is the voice information sequence, the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and outputting the speech information output by the different pronunciation objects by calling a second interface, where the second interface includes a second parameter, and a value of the second parameter is the speech information output by the different pronunciation objects.

The embodiment of the present application performs the gated processing on the acquired speech features in the speech feature sequence according to the local attention mechanism and the global attention mechanism, and can obtain the local speech information and the global speech information of the different pronunciation objects. Based on the gated processing, a requirement of the local attention mechanism and the global attention mechanism is substantially reduced, so that not only global information can be directly processed, but also smaller local features can be processed, thereby realizing the technical effect of being able to perform a speech separation on the speech, and thereby solving the technical problem of being unable to perform a speech separation on the speech.

A person of ordinary skill in the art may understand that the structure shown in FIG. 18 is only schematic, and the computer terminal A may also be a smartphone (e.g., a tablet computer, a palm computer, and a terminal device such as a mobile internet device (MID), a PAD, etc. FIG. 18 does not limit the structure of the above computer terminal A. For example, the computer terminal A may also include more or fewer components (e.g., a network interface, a display apparatus, etc.) than shown in FIG. 18, or have a different configuration than shown in FIG. 18.

A person of ordinary skill in the art can understand that all or part of the steps in the various methods of the above embodiments can be completed by instructing hardware related to a terminal device through a program, and the program can be stored in a computer-readable storage medium, and the storage medium may include: a flash disk, a read-only memory (ROM), a random access memory (RAM), a magnetic disk or an optical disk, etc.

### Embodiment 5

An embodiment of the present application also provides a computer-readable storage medium. In this embodiment, the computer-readable storage medium may be configured to store program codes executed by speech separation methods provided in the above Embodiment 1.

In this embodiment, the computer-readable storage medium may be located in any one of computer terminals in a computer terminal group in a computer network, or in any one of mobile terminals in a mobile terminal group.

In this embodiment, the computer-readable storage medium is configured to store program codes for executing the following steps: acquiring a speech information sequence, where the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; and separating speech information output by the different pronunciation objects from the speech information sequence based on the speech mask information of the different pronunciation objects and the speech feature sequence.

In an implementation, the computer-readable storage medium may also store program codes of the following steps: converting the speech features in the speech feature sequence according to a single-head attention mechanism to obtain the local speech information; converting the speech features in the speech feature sequence according to a linear attention mechanism to obtain the global speech information; and performing the gated processing on the local speech information and the global speech information to obtain the gated processing result.

In an implementation, the computer-readable storage medium may also store program codes of the following steps: performing a convolution processing on the speech features in the speech feature sequence to obtain a speech feature matrix of a target dimension; and converting the speech feature matrix according to the linear attention mechanism to obtain the global speech information.

In an implementation, the computer-readable storage medium may also store program codes of the following steps: converting a blocked speech feature matrix of the speech feature matrix according to the single-head attention mechanism to obtain the local speech information.

In an implementation, the computer-readable storage medium may also store program codes of the following steps: acquiring combined speech information between the global speech information and the local speech information; and performing the gated processing on the combined speech information, the speech feature matrix and the speech feature sequence to obtain the gated processing result.

In an implementation, the computer-readable storage medium may also store program codes of the following steps: performing the convolution processing on the speech features in the speech feature sequence for multiple times to obtain speech feature matrices of different target dimensions.

In an implementation, the computer-readable storage medium may also store program codes of the following steps: performing a normalization processing on the speech feature sequence to obtain a normalized speech result; encoding the normalized speech result to obtain a speech encoding result; performing a convolution processing on the speech encoding result, and converting an obtained convolution result to obtain a speech feature matrix of an original dimension; and performing a convolution processing on the speech feature matrix of the original dimension to obtain the speech feature matrix of the target dimension.

In an implementation, the computer-readable storage medium may also store program codes of the following steps: performing a convolution processing on the speech information sequence to obtain the speech features of the different pronunciation objects; and performing a linear processing on the speech features of the different pronunciation objects to obtain the speech feature sequence.

In an implementation, the computer-readable storage medium may also store program codes of the following steps: performing a linear processing on the gated processing result, and performing a convolution processing on an obtained linear processing result to obtain the speech mask information of the different pronunciation objects.

In an implementation, the computer-readable storage medium may also store program codes of the following steps: acquiring a product result between the speech mask information of the different pronunciation objects and the speech feature sequence; and determining the product result as the speech information output by the different pronunciation objects.

As an example, the computer-readable storage medium is configured to store program codes for executing the following steps: acquiring a speech information sequence, where the speech information sequence includes at least one piece of speech information to be speech separated, and different speech information originates from different pronunciation objects; calling a speech separation model, where the speech separation model is obtained by training based on a local attention mechanism and a global attention mechanism; extracting speech features of the different pronunciation objects from the speech information sequence to obtain a speech feature sequence by using the speech separation model, and performing a gated processing on the speech features in the speech feature sequence according to the local attention mechanism and the global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; and separating speech information output by the different pronunciation objects from the speech information sequence based on the speech mask information of the different pronunciation objects and the speech feature sequence.

As an example, the computer-readable storage medium is configured to store program codes for executing the following steps: extracting speech features of different pronunciation objects from an acquired speech information sequence to obtain a speech feature sequence, where the speech information sequence includes at least one piece of speech information to be speech separated, and different speech information originates from the different pronunciation objects; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and playing the speech information output by the different pronunciation objects respectively.

As an example, the computer-readable storage medium is configured to store program codes for executing the following steps: extracting speech features of different pronunciation objects from an acquired speech information sequence to obtain a speech feature sequence, where the speech information sequence includes at least one piece of speech information to be speech separated, and different speech information originates from the different pronunciation objects; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and inputting the speech information output by the different pronunciation objects into a speech recognition terminal, where the speech information is used to be recognized by the speech recognition terminal.

As an example, the computer-readable storage medium is configured to store program codes for executing the following steps: acquiring a speech information sequence by calling a first interface, where the first interface includes a first parameter, a parameter value of the first parameter is the voice information sequence, the speech information sequence includes at least one piece of speech information to be speech separated, and different speech information originates from different pronunciation objects; extracting speech features of the different pronunciation objects from the speech information sequence to obtain a speech feature sequence; performing a gated processing on the speech features in the speech feature sequence according to a local attention mechanism and a global attention mechanism to obtain a gated processing result, where the gated processing result includes local speech information and global speech information of the different pronunciation objects, and an information granularity of the local speech information is smaller than an information granularity of the global speech information; acquiring speech mask information of the different pronunciation objects based on the gated processing result, where the speech mask information is used to represent a pronunciation attribute of the pronunciation object; separating speech information output by the different pronunciation objects from the speech information sequence based on the speech mask information of the different pronunciation objects and the speech feature sequence; and outputting the speech information output by the different pronunciation objects by calling a second interface, where the second interface includes a second parameter, and a value of the second parameter is the speech information output by the different pronunciation objects.

Serial numbers of the above embodiments of the present application are for description only and do not represent advantages or disadvantages of the embodiments.

In the above embodiments of the present application, the description of each embodiment has its own emphasis. For parts that are not described in detail in a certain embodiment, please refer to the relevant description of other embodiments.

In several embodiments provided in the present application, it should be understood that the disclosed technical contents can be implemented in other ways. The apparatus embodiments described above are only schematic. For example, the division of units is only a logical function division, and there may be other divisions in actual implementation. For example, multiple units or components can be combined or integrated into another system, or some features can be ignored or not executed. Another point is that a mutual coupling or a direct coupling or a communication connection shown or discussed may be an indirect coupling or a communication connection through some interfaces, units or modules, which may be electrical or other forms.

The units described as separate components may or may not be physically separated, and the components shown as units may or may not be physical units, that is, may be located in one place or may be distributed over multiple network units. Some or all of the units may be selected according to actual needs to achieve a purpose of the solution of the present embodiment.

In addition, each functional unit in each embodiment of the present application may be integrated into one processing unit, or each unit may exist physically separately, or two or more units may be integrated into one unit. The above integrated unit can be implemented in a form of hardware or in a form of a software functional unit.

If an integrated unit is implemented in a form of a software functional unit and sold or used as an independent product, it can be stored in a computer-readable storage medium. Based on this understanding, a technical solution of the present application, or a part that contributes to prior art, or all or part of a technical solution can be embodied in a form of a software product. The computer software product is stored in a storage medium and includes a number of instructions for enabling a computer device (which may be a personal computer, a server or a network device, etc.) to execute all or part of steps of a method described in each embodiment of the present application. The above storage media includes: a U disk, a read-only memory (ROM), a random access memory (RAM), a mobile hard disk, a magnetic disk or an optical disk and other media that can store program codes.

The above is only a preferred implementation of the present application. It should be pointed out that for a person of ordinary skill in this technical field, several improvements and modifications can be made without departing from the principle of the present application. These improvements and modifications should also be regarded as the scope of protection of the present application.

1. A speech separation method, comprising:
acquiring a speech information sequence, wherein the speech information sequence comprises at least one piece of speech information to be speech separated, and different speech information originates from different pronunciation objects;
extracting speech features of the different pronunciation objects from the speech information sequence to obtain a speech feature sequence;
performing a gated processing on the speech features in the speech feature sequence according to a local attention mechanism and a global attention mechanism to obtain a gated processing result, wherein the gated processing result comprises local speech information and global speech information of the different pronunciation objects, and an information granularity of the local speech information is smaller than an information granularity of the global speech information;
acquiring speech mask information of the different pronunciation objects based on the gated processing result, wherein the speech mask information is used to represent a pronunciation attribute of the pronunciation object; and
separating speech information output by the different pronunciation objects from the speech information sequence based on the speech mask information of the different pronunciation objects and the speech feature sequence.

2. The method according to claim 1, wherein the local attention mechanism comprises a single-head attention mechanism, and the global attention mechanism comprises a linear attention mechanism, the performing the gated processing on the speech features in the speech feature sequence according to the local attention mechanism and the global attention mechanism to obtain the gated processing result comprises:
converting the speech features in the speech feature sequence according to the single-head attention mechanism to obtain the local speech information;
converting the speech features in the speech feature sequence according to the linear attention mechanism to obtain the global speech information; and
performing the gated processing on the local speech information and the global speech information to obtain the gated processing result.

3. The method according to claim 2, further comprising:
performing a convolution processing on the speech features in the speech feature sequence to obtain a speech feature matrix of a target dimension; and
the converting the speech features in the speech feature sequence according to the linear attention mechanism to obtain the global speech information comprises: converting the speech feature matrix according to the linear attention mechanism to obtain the global speech information.

4. The method according to claim 3, wherein the converting the speech features in the speech feature sequence according to the single-head attention mechanism to obtain the local speech information comprises:
converting a blocked speech feature matrix of the speech feature matrix according to the single-head attention mechanism to obtain the local speech information.

5. The method according to claim 4, wherein the performing the gated processing on the local speech information and the global speech information to obtain the gated processing result comprises:
acquiring combined speech information between the global speech information and the local speech information; and
performing the gated processing on the combined speech information, the speech feature matrix and the speech feature sequence to obtain the gated processing result.

6. The method according to claim 3, wherein the performing the convolution processing on the speech features in the speech feature sequence to obtain the speech feature matrix of the target dimension comprises:
performing the convolution processing on the speech features in the speech feature sequence for multiple times to obtain speech feature matrices of different target dimensions.

7. The method according to claim 3, further comprising:
performing a normalization processing on the speech feature sequence to obtain a normalized speech result;
encoding the normalized speech result to obtain a speech encoding result;
performing a convolution processing on the speech encoding result, and converting an obtained convolution result to obtain a speech feature matrix of an original dimension;
wherein the performing the convolution processing on the speech features in the speech feature sequence to obtain the speech feature matrix of the target dimension comprises: performing a convolution processing on the speech feature matrix of the original dimension to obtain the speech feature matrix of the target dimension.

8. The method according to claim 1, wherein the extracting the speech features of the different pronunciation objects from the speech information sequence to obtain the speech feature sequence comprises:
performing a convolution processing on the speech information sequence to obtain the speech features of the different pronunciation objects; and
performing a linear processing on the speech features of the different pronunciation objects to obtain the speech feature sequence.

9. The method according to claim 1, wherein the acquiring the speech mask information of the different pronunciation objects based on the gated processing result comprises:
performing a linear processing on the gated processing result, and performing a convolution processing on an obtained linear processing result to obtain the speech mask information of the different pronunciation objects.

10. The method according to claim 1, wherein the separating the speech information output by the different pronunciation objects from the speech information sequence based on the speech mask information of the different pronunciation objects and the speech feature sequence comprises:
acquiring a product result between the speech mask information of the different pronunciation objects and the speech feature sequence; and
determining the product result as the speech information output by the different pronunciation objects.

11. A speech separation method, comprising:
acquiring a speech information sequence, wherein the speech information sequence comprises at least one piece of speech information to be speech separated, and different speech information originates from different pronunciation objects;
calling a speech separation model, wherein the speech separation model is obtained by training based on a local attention mechanism and a global attention mechanism;
extracting speech features of the different pronunciation objects from the speech information sequence to obtain a speech feature sequence by using the speech separation model, and performing a gated processing on the speech features in the speech feature sequence according to the local attention mechanism and the global attention mechanism to obtain a gated processing result, wherein the gated processing result comprises local speech information and global speech information of the different pronunciation objects, and an information granularity of the local speech information is smaller than an information granularity of the global speech information;
acquiring speech mask information of the different pronunciation objects based on the gated processing result, wherein the speech mask information is used to represent a pronunciation attribute of the pronunciation object; and
separating speech information output by the different pronunciation objects from the speech information sequence based on the speech mask information of the different pronunciation objects and the speech feature sequence.

12-14. (canceled)

15. A computer terminal, comprising:
a processor; and
a memory, configured to store program instructions;
wherein the processor, when executing the program instructions, is configured to:
acquire a speech information sequence, wherein the speech information sequence comprises at least one piece of speech information to be speech separated, and different speech information originates from different pronunciation objects;
extract speech features of the different pronunciation objects from the speech information sequence to obtain a speech feature sequence;
perform a gated processing on the speech features in the speech feature sequence according to a local attention mechanism and a global attention mechanism to obtain a gated processing result, wherein the gated processing result comprises local speech information and global speech information of the different pronunciation objects, and an information granularity of the local speech information is smaller than an information granularity of the global speech information;
acquire speech mask information of the different pronunciation objects based on the gated processing result, wherein the speech mask information is used to represent a pronunciation attribute of the pronunciation object; and
separate speech information output by the different pronunciation objects from the speech information sequence based on the speech mask information of the different pronunciation objects and the speech feature sequence.

16. The computer terminal according to claim 15, wherein the local attention mechanism comprises a single-head attention mechanism, and the global attention mechanism comprises a linear attention mechanism, and the processor is configured to:
convert the speech features in the speech feature sequence according to the single-head attention mechanism to obtain the local speech information;
convert the speech features in the speech feature sequence according to the linear attention mechanism to obtain the global speech information; and
perform the gated processing on the local speech information and the global speech information to obtain the gated processing result.

17. The computer terminal according to claim 16, wherein the processor is configured to:
perform a convolution processing on the speech features in the speech feature sequence to obtain a speech feature matrix of a target dimension; and
convert the speech feature matrix according to the linear attention mechanism to obtain the global speech information.

18. The computer terminal according to claim 17, wherein the processor is configured to:
convert a blocked speech feature matrix of the speech feature matrix according to the single-head attention mechanism to obtain the local speech information.

19. The computer terminal according to claim 18, wherein the processor is configured to:
acquire combined speech information between the global speech information and the local speech information; and
perform the gated processing on the combined speech information, the speech feature matrix and the speech feature sequence to obtain the gated processing result.

20. The computer terminal according to claim 17, wherein the processor is configured to:
perform the convolution processing on the speech features in the speech feature sequence for multiple times to obtain speech feature matrices of different target dimensions.

21. The computer terminal according to claim 17, wherein the processor is configured to:
perform a normalization processing on the speech feature sequence to obtain a normalized speech result;
encode the normalized speech result to obtain a speech encoding result;
perform a convolution processing on the speech encoding result, and convert an obtained convolution result to obtain a speech feature matrix of an original dimension; and
performing a convolution processing on the speech feature matrix of the original dimension to obtain the speech feature matrix of the target dimension.

22. The computer terminal according to claim 15, wherein the processor is configured to:
perform a convolution processing on the speech information sequence to obtain the speech features of the different pronunciation objects; and
perform a linear processing on the speech features of the different pronunciation objects to obtain the speech feature sequence.

23. The computer terminal according to claim 15, wherein the processor is configured to:
perform a linear processing on the gated processing result, and perform a convolution processing on an obtained linear processing result to obtain the speech mask information of the different pronunciation objects.
